(19) United States
(12) Patent Application Publication
(10) Pub. No.: US 2025/0203674 A1
(43) Pub. Date: Jun. 19, 2025

(54) PROCESSING METHOD, COMMUNICATION DEVICE AND STORAGE MEDIUM

(71) Applicant: SHENZHEN TRANSSION HOLDINGS CO., LTD., Shenzhen (CN)

(72) Inventors: Rongchang ZHU, Shenzhen (CN); Wei HUANG, Shenzhen (CN); Chiunwei HUANG, Shenzhen (CN)

(73) Assignee: SHENZHEN TRANSSION HOLDINGS CO., LTD., Shenzhen (CN)

(21) Appl. No.: 19/070,788

(22) Filed: Mar. 5, 2025

Related U.S. Application Data
(63) Continuation of application No. PCT/CN2022/118209, filed on Sep. 9, 2022.

(51) Int. Cl. H04W 74/08; H04W 28/02; H04W 56/00; H04W 72/25; H04W 74/00; H04W 92/18

(52) U.S. Cl. CPC H04W 74/0875; H04W 28/0268; H04W 56/001; H04W 72/25; H04W 74/006; H04W 92/18

(57) ABSTRACT

Disclosed are a processing method, a communication device and a storage medium. The processing method includes: in response to satisfying a preset condition, accessing a channel with a preset channel access priority class. Through the above method, different physical channels can use different channel access priority classes, thereby improving the utilization of the unlicensed spectrum.

### CROSS-REFERENCE TO RELATED APPLICATIONS

This application is a continuation application of International Application No. PCT/CN2022/118209, filed on Sep. 9, 2022, the content of which is incorporated herein by reference in its entirety.

### TECHNICAL FIELD

The present application relates to the technical field of communication, and in particular to a processing method, a communication device and a storage medium.

### BACKGROUND

In a sidelink-unlicense (SL-U) system, if an unlicensed frequency band is used for data transmission and reception, the transmitter of the signal needs to meet the usage rules of the unlicensed frequency band. For the unlicensed frequency band, before transmitting a signal, the transmitter needs to monitor whether the frequency band is occupied (or idle). If the frequency band is not occupied (or idle), the transmitter can transmit the signal.

At present, in the SL-U system, the inventor has found the following problems: for different physical channels, the same channel access priority class is still used, and different physical channels use the same channel access parameters to access the unlicensed spectrum, resulting in low utilization of the unlicensed spectrum.

The preceding description is intended to provide general background information and does not necessarily constitute related art.

### SUMMARY

In view of the above technical problems, the present application provides a processing method, a communication device and a storage medium, aiming to solve the technical problem that in the sidelink-unlicense (SL-U) system, for different physical channels, the same channel access priority class is used to achieve different physical channels using the same channel access parameters to access the unlicensed spectrum, resulting in low utilization of the unlicensed spectrum.

In order to solve the above technical problem, in a first aspect, the present application provides a processing method, which can be applied to a terminal device (such as a mobile phone), including:
step S10, in response to satisfying a preset condition, accessing a channel with a preset channel access priority class; and
determining the channel access priority class according to a type of a transmitted channel.

In an embodiment, the satisfying the preset condition includes at least one of the following:
transmitted physical channels are different;
types of services contained in the transmitted channels are different;
there are different receivers;
there are different transmitters; and
channel priorities are different.

In an embodiment, the transmitted physical channel further includes at least one of the following:
transmitting a physical sidelink control channel;
transmitting a physical sidelink shared channel;
transmitting a physical sidelink feedback channel; and
transmitting a sidelink-synchronization signal/physical sidelink broadcast channel block.

In an embodiment, the types of services contained in the transmitted channel further include at least one of the following:
the types of services contained in the transmitted channel include broadcast or groupcast;
the types of services contained in the transmitted channel include unicast; or
the types of services contained in the transmitted channel include unicast, broadcast and groupcast.

In an embodiment, a way for determining the preset channel access priority class includes at least one of the following:
determining the channel access priority class according to a type of service contained in a transmitting channel;
determining the channel access priority class according to downlink control information or a type of the transmitting channel;
determining the channel access priority class according to a logical channel corresponding to a physical sidelink shared channel;
determining the channel access priority class according to a receiver identifier of the physical sidelink shared channel;
determining the channel access priority class according to a transmitter identifier of the physical sidelink shared channel;
determining the channel access priority class based on the receiver identifier and the transmitter identifier of the physical sidelink shared channel;
determining the channel access priority class according to number of receivers;
determining the channel access priority class based on per-packet priority PPPP of proximity communication; and
determining the channel access priority class according to PC5 5G QoS identifier value.

In an embodiment, the method further includes at least one of the following:
in response to that the type of service contained in the transmitting channel includes broadcast and/or groupcast, using a first set channel access priority class to determine the channel access priority class; or
in response to that the type of service contained in the transmitting channel is unicast, using a second set channel access priority class to determine the channel access priority class.

In an embodiment, the method further includes at least one of the following:
the first set channel access priority class and the second set channel access priority class belong to different channel access priority class tables respectively;
the first set channel access priority class and the second set channel access priority class belong to different elements in the same channel access priority class table.

In an embodiment, the method further includes at least one of the following:
determining a channel access priority class table according to the downlink control information, and determining the channel access priority class according to the channel access priority class table.

In an embodiment, a table indicated by the downlink control information is configured according to radio resource control (RRC) signaling; and/or, the determining the channel access priority class table according to the downlink control information further includes at least one of the following:
determining the channel access priority class table according to bit field in the downlink control information;
determining the channel access priority class table according to newly added column information in the table indicated by the downlink control information; and
determining the channel access priority class table according to newly added index information in the table indicated by the downlink control information.

In an embodiment, the method further includes at least one of the following:
in response to transmitting the physical sidelink shared channel, determining the channel access priority class;
in response to transmitting a physical sidelink control channel, determining the channel access priority class;
in response to transmitting a physical sidelink feedback channel, determining the channel access priority class; and
in response to transmitting a sidelink-synchronization signal/physical sidelink broadcast channel block, determining the channel access priority class.

In an embodiment, the method further includes at least one of the following:
determining the channel access priority class of the physical sidelink feedback channel according to the channel access priority class to which the corresponding physical sidelink shared channel belongs;
determining a fixed preset value as the channel access priority class of the physical sidelink feedback channel;
determining the channel access priority class of the physical sidelink feedback channel according to a priority of the corresponding physical sidelink shared channel;
in response to that at least two physical sidelink feedback channels are transmitted at the same physical sidelink feedback channel occasion or in the same slot, determining the channel access priority class of the transmitting terminal at the physical sidelink feedback channel occasion or in the time slot according to the physical sidelink feedback channel with a higher channel access priority class; and
in response to that at least two physical sidelink feedback channels start to be sent at the same slot and/or symbol, determining the channel access priority class of the transmitting terminal at the same slot and/or symbol of the physical sidelink feedback channel according to the physical sidelink feedback channel with a higher channel access priority class.

In an embodiment, the method further includes at least one of the following:
in response to that the number of receivers is greater than 1, determining the channel access priority class according to a priority of the receiver with lowest priority;
in response to that the number of receivers is greater than 1, determining the channel access priority class according to a priority of the receiver with highest priority; and
in response to that the number of receivers is greater than 1, determining the channel access priority class according to a priority of a randomly selected receiver.

In an embodiment, a way for determining the channel access priority class based on the receiver identifier and the transmitter identifier of the physical sidelink shared channel further includes at least one of the following:
determining a minimum channel access priority class based on the receiver identifier and the transmitter identifier as the channel access priority class; or
determining a maximum channel access priority class based on the receiver identifier and the transmitter identifier as the channel access priority class.

In an embodiment, the method further includes at least one of the following:
determining the channel access priority class based on a resource type corresponding to the PC5 5G QoS identifier value;
determining the channel access priority class based on a default priority corresponding to the PC5 5G QoS identifier value;
determining the channel access priority class based on a packet error rate corresponding to the PC5 5G QoS identifier value; and
determining the channel access priority class based on a packet delay budget corresponding to the PC5 5G QoS identifier value.

In an embodiment, the method further includes at least one of the following:

determining at least one parameter of a defer duration, an allowed contention window size, and a maximum channel occupancy time.

The present application further provides a processing method, applied to a network device (such as a base station), including:

A10: transmitting downlink control information so that a terminal device uses the downlink control information to determine a channel access priority class and access a channel with a preset channel access priority class.

In an embodiment, a table indicated by the downlink control information is configured according to RRC signaling; and/or the transmitting the downlink control information so that the terminal device uses the downlink control information to determine the channel access priority class further includes at least one of the following:
determining, by the terminal device, the channel access priority class table according to the bit field in the downlink control information;
determining, by the terminal device, the channel access priority class table according to the newly added column information in the table indicated by the downlink control information; and
determining, by the terminal device, the channel access priority class table according to the newly added index information in the table indicated by the downlink control information.

In an embodiment, a table indicated by the downlink control information is configured according to RRC signaling.

The present application further provides a communication device, including: a memory, a processor, and a processing program stored in the memory and executable on the processor, and the processing program implements the steps of any one of the processing methods as described above when executed by the processor.

The communication device of the present application may be a terminal device (such as a phone), or a network device (such as a base station). The specific reference needs to be clarified based on the context.

The present application further provides a storage medium, a computer program is stored in the storage medium, and when the computer program is executed by a processor, the steps of any one of the processing methods as described above are implemented.

The present application further provides a communication apparatus, including: a processing module configured to in response to satisfying a preset condition, access a channel with a preset channel access priority class.

In an embodiment, the satisfying the preset condition includes at least one of the following:
transmitted physical channels are different;
types of services contained in the transmitted channels are different;
there are different receivers;
there are different transmitters; and
channel priorities are different.

In an embodiment, the transmitted physical channel further includes at least one of the following:
transmitting a physical sidelink control channel;
transmitting a physical sidelink shared channel;
transmitting a physical sidelink feedback channel; and
transmitting a Sidelink-Synchronization Signal/Physical Sidelink Broadcast Channel block.

In an embodiment, the types of services contained in the transmitted channel further include at least one of the following:
the types of services contained in the transmitted channel include broadcast or groupcast;
the types of services contained in the transmitted channel include unicast; or
the types of services contained in the transmitted channel include unicast, broadcast and groupcast.

In an embodiment, a way for determining the preset channel access priority class includes at least one of the following:
determining the channel access priority class according to a type of service contained in a transmitting channel;
determining the channel access priority class according to downlink control information or a type of the transmitting channel;
determining the channel access priority class according to a logical channel corresponding to a physical sidelink shared channel;
determining the channel access priority class according to a receiver identifier of the physical sidelink shared channel;
determining the channel access priority class according to a transmitter identifier of the physical sidelink shared channel;
determining the channel access priority class based on the receiver identifier and the transmitter identifier of the physical sidelink shared channel;
determining the channel access priority class according to number of receivers;
determining the channel access priority class based on per-packet priority PPPP of proximity communication; and
determining the channel access priority class according to PC5 5G QOS identifier value.

In an embodiment, the processing module is configured to realize:
in response to that the type of service contained in the transmitting channel includes broadcast and/or groupcast, using a first set channel access priority class to determine the channel access priority class; or
in response to that the type of service contained in the transmitting channel is unicast, using a second set channel access priority class to determine the channel access priority class.

In an embodiment, the processing module is configured to realize:
the first set channel access priority class and the second set channel access priority class belong to different channel access priority class tables respectively;
the first set channel access priority class and the second set channel access priority class belong to different elements in the same channel access priority class table.

In an embodiment, the processing module is configured to realize:
determining a channel access priority class table according to the downlink control information, and determining the channel access priority class according to the channel access priority class table.

In an embodiment, a table indicated by the downlink control information is configured according to RRC signaling; and/or, the processing module is configured to realize:
determining the channel access priority class table according to bit field in the downlink control information;
determining the channel access priority class table according to newly added column information in the table indicated by the downlink control information; and
determining the channel access priority class table according to newly added index information in the table indicated by the downlink control information.

In an embodiment, a table indicated by the downlink control information is configured according to RRC signaling.

In an embodiment, the processing module is configured to realize:
in response to transmitting the physical sidelink shared channel, determining the channel access priority class;
in response to transmitting a physical sidelink control channel, determining the channel access priority class;
in response to transmitting a physical sidelink feedback channel, determining the channel access priority class; and
in response to transmitting a Sidelink-Synchronization Signal/Physical Sidelink Broadcast Channel block, determining the channel access priority class.

In an embodiment, the processing module is configured to realize:
determining the channel access priority class of the physical sidelink feedback channel according to the channel access priority class to which the corresponding physical sidelink shared channel belongs;
determining a fixed preset value as the channel access priority class of the physical sidelink feedback channel;
determining the channel access priority class of the physical sidelink feedback channel according to a priority of the corresponding physical sidelink shared channel;
in response to that at least two physical sidelink feedback channels are transmitted at the same physical sidelink feedback channel occasion or in the same slot, determining the channel access priority class of the transmitting terminal at the physical sidelink feedback channel occasion or in the time slot according to the physical sidelink feedback channel with a higher channel access priority class; and
in response to that at least two physical sidelink feedback channels start to be sent at the same slot and/or symbol, determining the channel access priority class of the transmitting terminal at the same slot and/or symbol of the physical sidelink feedback channel according to the physical sidelink feedback channel with a higher channel access priority class.

In an embodiment, the processing module is configured to realize:
in response to that the number of receivers is greater than 1, determining the channel access priority class according to a priority of the receiver with lowest priority;
in response to that the number of receivers is greater than 1, determining the channel access priority class according to a priority of the receiver with highest priority; and
in response to that the number of receivers is greater than 1, determining the channel access priority class according to a priority of a randomly selected receiver.

In an embodiment, the processing module is configured to realize:
determining a minimum channel access priority class based on the receiver identifier and the transmitter identifier as the channel access priority class; or
determining a maximum channel access priority class based on the receiver identifier and the transmitter identifier as the channel access priority class.

In an embodiment, the processing module is configured to realize:
determining the channel access priority class based on a resource type corresponding to the PC5 5G QoS identifier value;
determining the channel access priority class based on a default priority corresponding to the PC5 5G QoS identifier value;
determining the channel access priority class based on a packet error rate corresponding to the PC5 5G QoS identifier value; and
determining the channel access priority class based on a packet delay budget corresponding to the PC5 5G QoS identifier value.

In an embodiment, the processing module is configured to realize: determining at least one parameter of a defer duration, an allowed contention window size, and a maximum channel occupancy time.

As described above, the processing method of the present application enables a channel to be accessed with a preset channel access priority class in response to satisfying a preset condition. Since the present application explicitly defines channel access priority classes in the SL-U system, different physical channels can be assigned different channel access priority classes. This ensures that different physical channels use different channel access parameters when accessing the unlicensed spectrum, thereby improving the utilization of the unlicensed spectrum.

### BRIEF DESCRIPTION OF THE DRAWINGS

The accompanying drawings, which are incorporated in and constitute a part of this specification, illustrate embodiments consistent with the present application and together with the description, serve to explain the principles of the present application. In order to explain the technical solutions of the embodiments of the present application more clearly, the drawings needed to be used in the description of the embodiments will be briefly introduced below. Obviously, for those skilled in the art, other drawings can be obtained based on these drawings without exerting creative efforts.

FIG. 1 is a schematic diagram of hardware structure of a terminal for implementing various embodiments of the present application according to an embodiment of the present application.

FIG. 2 is a diagram of architecture of a communication network system according to an embodiment of the present application.

FIG. 3 is a flowchart of a processing method according to an embodiment of the present application.

FIG. 4 is a detailed flowchart of step S10 of the processing method according to an embodiment of the present application.

FIG. 5 is a distribution diagram of N idle channels in a random backoff contention window provided by an embodiment of the present application.

FIG. 6 is a flowchart of a processing method according to another embodiment of the present application.

FIG. 7 is a schematic structural diagram of a communication apparatus according to an embodiment of the present application.

FIG. 8 is a schematic structural diagram of another communication device according to an embodiment of the present application.

FIG. 9 is a schematic diagram of hardware structure of a controller 140 according to an embodiment of the present application.

FIG. 10 is a schematic diagram of hardware structure of a network node 150 according to an embodiment of the present application.

The realization of the purpose, functional features and advantages of the present application will be further described with reference to the embodiments and the accompanying drawings. Through the above-mentioned drawings, clear embodiments of the present application have been shown, which will be described in more detail below. These drawings and text descriptions are not intended to limit the scope of the present application's concepts in any way, but are intended to illustrate the present application's concepts for those skilled in the art with reference to specific embodiments.

### DETAILED DESCRIPTION OF THE EMBODIMENTS

Exemplary embodiments will be described in detail herein, examples of which are illustrated in the accompanying drawings. When the following description refers to the drawings, unless otherwise indicated, the same numbers in different drawings refer to the same or similar elements. The implementations described in the following exemplary embodiments do not represent all implementations consistent with the present application. Rather, they are merely examples of apparatus and methods consistent with aspects of the present application as detailed in the appended claims.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element. In addition, components, features, and elements with the same name in different embodiments of the present application may have the same or different meanings. Its specific meaning needs to be determined according to its explanation in the specific embodiment or further combined with the context in the specific embodiment.

It should be understood that although the terms first, second, third, etc. may be used herein to describe various information, the information should not be limited to these terms. These terms are only used to distinguish information of the same type from one another. For example, without departing from the scope of this document, first information may also be called second information, and similarly, second information may also be called first information. Depending on the context, the word “if” as used herein may be interpreted as “at” or “when” or “in response to a determination”. Furthermore, as used herein, the singular forms “a”, “an” and “the” are intended to include the plural forms as well, unless the context indicates otherwise. It should be further understood that the terms “comprising”, “including” indicate the existence of features, steps, operations, elements, components, items, species, and/or groups, but does not exclude the existence, occurrence or addition of one or more other features, steps, operations, elements, components, items, species, and/or groups. The terms “or”, “and/or”, “comprising at least one of” and the like used in the present application may be interpreted as inclusive, or mean any one or any combination. For example, “comprising at least one of: A, B, C” means “any of: A; B; C; A and B; A and C; B and C; A and B and C”. As another example, “A, B, or C” or “A, B, and/or C” means “any of the following: A; B; C; A and B; A and C; B and C; A and B and C”. Exceptions to this definition will only arise when combinations of elements, functions, steps or operations are inherently mutually exclusive in some way.

It should be understood that although the various steps in the flowchart in the embodiment of the present application are displayed sequentially as indicated by the arrows, these steps are not necessarily executed sequentially in the order indicated by the arrows. Unless otherwise specified herein, there is no strict order restriction on the execution of these steps, and they can be executed in other orders. Moreover, at least some of the steps in the figure may include multiple sub-steps or multiple stages, these sub-steps or stages are not necessarily executed at the same time, but can be executed at different times. The execution sequence thereof is not necessarily performed sequentially, but may be performed alternately or alternately with at least one part of other steps or sub-steps or stages of other steps.

Depending on the context, the words “if” as used herein may be interpreted as “at” or “when” or “in response to determining” or “in response to detecting”. Similarly, depending on the context, the phrases “if determined” or “if detected (the stated condition or event)” could be interpreted as “when determined” or “in response to the determination” or “when detected (the stated condition or event)” or “in response to detection (the stated condition or event)”.

It should be noted that in this article, step codes such as S11 and S12 are used for the purpose of expressing the corresponding content more clearly and concisely, and do not constitute a substantive limitation on the order. Those skilled in the art may perform S12 first and then S11 etc. during specific implementation, but these should all be within the protection scope of the present application.

It should be understood that the specific embodiments described here are only used to explain the present application, and are not intended to limit the present application.

In the following description, the use of suffixes such as “module”, “part” or “unit” for denoting elements is only for facilitating the description of the present application and has no specific meaning by itself. Therefore, “module”, “part” or “unit” may be used in combination. In an embodiment, the terminal device can be implemented in various forms. For example, the terminal device described in the present application can include a mobile phone, a tablet computer, a notepad computer, a hand-held computer, a personal digital assistants (PDA), a portable media player (PMP), a navigation device, a wearable device, a smart bracelet, a pedometer and other terminal devices, as well as a fixed terminal device such as a digital TV and a desktop computer.

The present application takes a mobile terminal as an example to illustrate. Those skilled in the art will understand that, in addition to elements specifically used for mobile purposes, the configuration according to the embodiments of the present application can also be applied to the fixed terminal device.

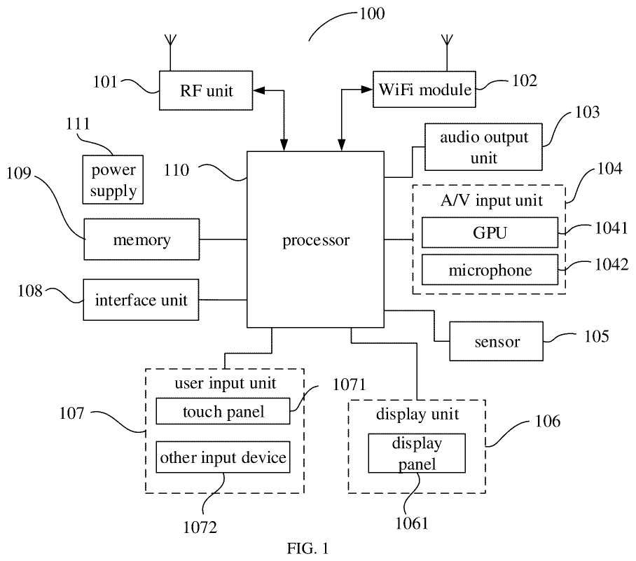

As shown in FIG. 1, FIG. 1 is a schematic structural diagram of a hardware of a mobile terminal that implements various embodiments of the present application. The mobile terminal 100 can include a Radio Frequency (RF) unit 101, a Wi-Fi module 102, an audio output unit 103, an audio/video (A/V) input unit 104, a sensor 105, a display unit 106, a user input unit 107, an interface unit 108, a memory 109, a processor 110, a power supply 111 and other components. Those skilled in the art can understand that the structure of the mobile terminal shown in FIG. 1 does not constitute a limitation on the mobile terminal. The mobile terminal can include more or fewer components, or a combination of some components, or differently arranged components than shown in the figure.

Hereinafter, each component of the mobile terminal will be specifically introduced with reference to FIG. 1.

The radio frequency unit 101 can be used for transmitting and receiving signals during the process of transceiving information or talking. Specifically, after receiving the downlink information of the base station, the downlink information is processed by the processor 110; in addition, the uplink data is sent to the base station. Generally, the radio frequency unit 101 includes, but is not limited to, an antenna, at least one amplifier, a transceiver, a coupler, a low noise amplifier, a duplexer, and the like. In addition, the radio frequency unit 101 can also communicate with the network and other devices through wireless communication. The above-mentioned wireless communication can use any communication standard or protocol, including but not limited to Global System of Mobile communication (GSM), General Packet Radio Service (GPRS), Code Division Multiple Access 2000 (CDMA2000), Wideband Code Division Multiple Access (WCDMA), Time Division-Synchronous Code Division Multiple Access (TD-SCDMA), Frequency Division Duplexing-Long Term Evolution (FDD-LTE), Time Division Duplexing-Long Term Evolution (TDD-LTE), and 5G, or the like.

Wi-Fi is a short-range wireless transmission technology. The mobile terminal can help users transmit and receive email, browse webpage, and access streaming media through the Wi-Fi module 102, and Wi-Fi provides users with wireless broadband Internet access. Although FIG. 1 shows the Wi-Fi module 102, it is understandable that it is not a necessary component of the mobile terminal and can be omitted as needed without changing the essence of the present application.

When the mobile terminal 100 is in a call signal receiving mode, a call mode, a recording mode, a voice recognition mode, a broadcast receiving mode, or the like, the audio output unit 103 can convert the audio data received by the radio frequency unit 101 or the Wi-Fi module 102 or stored in the memory 109 into an audio signal and output the audio signal as sound. Moreover, the audio output unit 103 can further provide audio output related to a specific function performed by the mobile terminal 100 (for example, call signal reception sound, message reception sound, or the like). The audio output unit 103 can include a speaker, a buzzer, or the like.

The A/V input unit 104 is configured to receive audio or video signals. The A/V input unit 104 can include a graphics processing unit (GPU) 1041 and a microphone 1042. The graphics processing unit 1041 processes image data of still pictures or videos obtained by an image capture device (such as a camera) in a video capture mode or an image capture mode. The processed image frame can be displayed on the display unit 106. The image frame processed by the graphics processing unit 1041 can be stored in the memory 109 (or other storage medium) or sent via the radio frequency unit 101 or the Wi-Fi module 102. The microphone 1042 can receive sound (audio data) in operation modes such as a call mode, a recording mode, a voice recognition mode, and the like, and can process such sound into audio data. The processed audio (voice) data can be converted into a format that can be sent to a mobile communication base station via the radio frequency unit 101 in the case of a call mode for output. The microphone 1042 can implement various types of noise cancellation (or suppression) algorithms to eliminate (or suppress) noise or interference generated during the process of transceiving audio signals.

The mobile terminal 100 also includes at least one sensor 105, such as a light sensor, a motion sensor, and other sensors. Specifically, the light sensor includes an ambient light sensor and a proximity sensor. The ambient light sensor can adjust the brightness of the display panel 1061 according to the brightness of the ambient light. The proximity sensor can turn off the display panel 1061 and/or the backlight when the mobile terminal 100 is moved to the ear. A gravity acceleration sensor, as a kind of motion sensor, can detect the magnitude of acceleration in various directions (usually three axes). The gravity acceleration sensor can detect the magnitude and direction of gravity when it is stationary, and can identify the gesture of the mobile terminal (such as horizontal and vertical screen switching, related games, magnetometer attitude calibration), vibration recognition related functions (such as pedometer, tap), or the like. The mobile terminal can also be equipped with other sensors such as a fingerprint sensor, a pressure sensor, an iris sensor, a molecular sensor, a gyroscope, a barometer, a hygrometer, a thermometer, an infrared sensor and other sensors, which will not be repeated here.

The display unit 106 is configured to display information input by the user or information provided to the user. The display unit 106 can include a display panel 1061, and the display panel 1061 can be configured in the form of a liquid crystal display (LCD), an organic light emitting diode (OLED), or the like.

The user input unit 107 can be configured to receive inputted numeric or character information, and generate key signal input related to user settings and function control of the mobile terminal. Specifically, the user input unit 107 can include a touch panel 1071 and other input devices 1072. The touch panel 1071, also called a touch screen, can collect user touch operations on or near it (for example, the user uses fingers, stylus and other suitable objects or accessories to operate on the touch panel 1071 or near the touch panel 1071), and drive the corresponding connection device according to a preset program. The touch panel 1071 can include two parts: a touch detection device and a touch controller. The touch detection device detects the user's touch position, detects the signal brought by the touch operation, and transmits the signal to the touch controller. The touch controller receives the touch information from the touch detection device, converts the touch information into contact coordinates, and sends it to the processor 110, and can receive and execute the instructions sent by the processor 110. In addition, the touch panel 1071 can be implemented in multiple types such as resistive, capacitive, infrared, and surface acoustic wave. In addition to the touch panel 1071, the user input unit 107 can also include other input devices 1072. Specifically, the other input devices 1072 can include, but are not limited to, one or more of physical keyboard, function keys (such as volume control buttons, switch buttons, etc.), trackball, mouse, joystick, etc., which are not specifically limited here.

Further, the touch panel 1071 can cover the display panel 1061. After the touch panel 1071 detects a touch operation on or near it, the touch operation is transmitted to the processor 110 to determine the type of the touch event, and then the processor 110 provides a corresponding visual output on the display panel 1061 according to the type of the touch event. Although in FIG. 1, the touch panel 1071 and the display panel 1061 are used as two independent components to realize the input and output functions of the mobile terminal, in some embodiments, the touch panel 1071 and the display panel 1061 can be integrated to implement the input and output functions of the mobile terminal, which is not specifically limited here.

The interface unit 108 serves as an interface through which at least one external device can be connected to the mobile terminal 100. For example, the external device can include a wired or wireless earphone port, an external power source (or battery charger) port, a wired or wireless data port, a memory card port, a port for connecting devices with identification modules, an audio input/output (I/O) port, a video I/O port, an earphone port, or the like. The interface unit 108 can be configured to receive input (such as data information, electricity, or the like) from an external device and transmit the received input to one or more elements in the mobile terminal 100 or can be configured to transfer data between the mobile terminal 100 and the external device.

The memory 109 can be configured to store software programs and various data. The memory 109 can mainly include a program storage area and a data storage area. The program storage area can store the operating system, at least one application required by the function (such as sound play function, image play function, etc.), or the like. The data storage area can store data (such as audio data, phone book, etc.) created based on the use of the mobile phone. In addition, the memory 109 can include a high-speed random access memory, and can also include a non-volatile memory, such as at least one magnetic disk storage device, a flash memory device, or other volatile solid-state storage devices.

The processor 110 is a control center of the mobile terminal, and uses various interfaces and lines to connect the various parts of the entire mobile terminal. By running or performing the software programs and/or modules stored in the memory 109, and calling the data stored in the memory 109, various functions and processing data of the mobile terminal are executed, thereby overall monitoring of the mobile terminal is performed. The processor 110 can include one or more processing units; and the processor 110 may integrate an application processor and a modem processor. The application processor mainly processes an operating system, a user interface, an application, or the like, and the modem processor mainly processes wireless communication. It can be understood that the foregoing modem processor may not be integrated into the processor 110.

The mobile terminal 100 can also include a power source 111 (such as a battery) for supplying power to various components. The power supply 111 can be logically connected to the processor 110 through a power management system, so that functions such as charging, discharging, and power consumption management can be managed through the power management system.

Although not shown in FIG. 1, the mobile terminal 100 can also include a Bluetooth module, or the like, which will not be repeated herein.

In order to facilitate the understanding of the embodiments of the present application, the following describes the communication network system on which the mobile terminal of the present application is based.

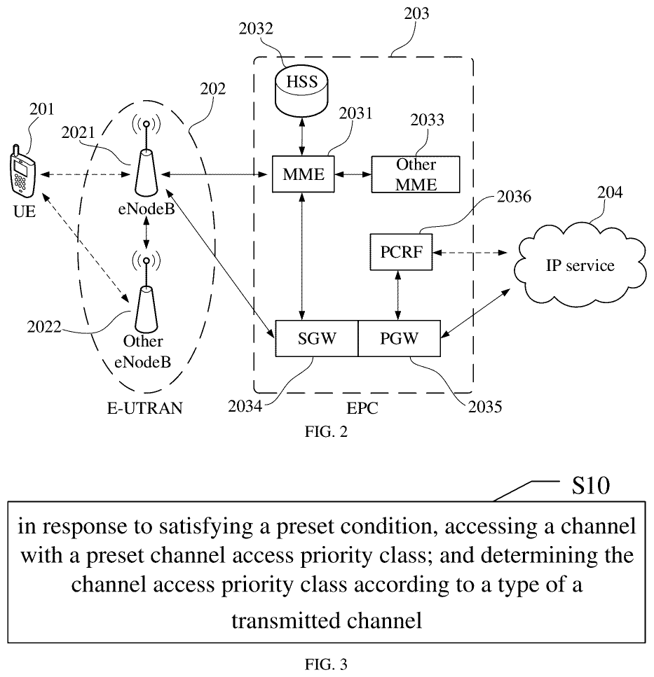

As shown in FIG. 2, FIG. 2 is an architecture diagram of a communication network system according to an embodiment of the present application. The communication network system is an LTE system of general mobile communication network technology. The LTE system includes a User Equipment (UE) 201, an Evolved UMTS Terrestrial Radio Access Network (E-UTRAN) 202, an Evolved Packet Core (EPC) 203, and an operator's IP service 204 that are sequentially connected in communication.

In an embodiment, the UE 201 can be the aforementioned terminal 100, which will not be repeated here.

E-UTRAN 202 includes eNodeB 2021 and other eNodeBs 2022. The eNodeB 2021 can be connected to other eNodeBs 2022 through a backhaul (for example, an X2 interface), the eNodeB 2021 is connected to the EPC 203, and the eNodeB 2021 can provide access from the UE 201 to the EPC 203.

The EPC 203 can include Mobility Management Entity (MME) 2031, Home Subscriber Server (HSS) 2032, other MMEs 2033, Serving Gate Way (SGW) 2034, PDN Gate Way (PGW) 2035, Policy and Charging Rules Function (PCRF) 2036, and so on. MME 2031 is a control node that processes signaling between UE 201 and EPC 203, and provides bearer and connection management. HSS 2032 is configured to provide some registers to manage functions such as the home location register (not shown), and save some user-specific information about service features, data rates, and so on. All user data can be sent through SGW 2034, PGW 2035 can provide UE 201 IP address allocation and other functions. PCRF 2036 is a policy and charging control policy decision point for service data flows and IP bearer resources, which selects and provides available policy and charging control decisions for policy and charging execution functional units (not shown).

The IP service 204 can include Internet, intranet, IP Multimedia Subsystem (IMS), or other IP services.

Although the LTE system is described above as an example, those skilled in the art should know that, the present application is not only applicable to the LTE system, but also applicable to other wireless communication systems, such as GSM, CDMA2000, WCDMA, TD-SCDMA, 5G and new network systems in the future (such as 6G), or the like, which is not limited herein.

Based on the above hardware structure of the mobile terminal and communication network system, various embodiments of the present application are proposed.

Please referring to FIG. 3, which is a flowchart of a processing method according to an embodiment of the present application. The method of the embodiment of the present application can be executed by a terminal device. In a first embodiment of the processing method of the present application, the method may include the following steps:

S10, in response to satisfying a preset condition, accessing a channel with a preset channel access priority class;
determining the channel access priority class according to a type of a transmitted channel

In an embodiment, the processing method is applied to a terminal device in an SL-U system. The terminal device, in response to satisfying the preset condition, accesses the channel with a preset channel access priority class. The present application explicitly defines the channel access priority class in the SL-U system, thereby enabling different physical channels to use different channel access priority classes, ensuring that different physical channels access the unlicensed spectrum with different channel access parameters, and thus improving the utilization of the unlicensed spectrum.

In an embodiment, in the SL-U system, the terminal device and the network device communicate directly without requiring communication through a base station.

In an embodiment, in the SL-U system, the terminal device may be various transmitters with a Wi-Fi module, a Bluetooth module.

In an embodiment, in the SL-U system, the transmitter may be an in-vehicle device such as a vehicle. Additionally, the transmitter may also be a smart home device such as a smart TV, a smart refrigerator, etc., with no specific limitation.

In an embodiment, in the SL-U system, the network device may specifically be a receiver with a Wi-Fi module, a Bluetooth module, etc.

In an embodiment, in the SL-U system, the receiver may be a vehicle, a mobile phone, a tablet, or another type of receiver, with no specific limitation.

In an embodiment, some application scenarios may include:

In a vehicle driving scenario, the first vehicle (transmitter) and the second vehicle (receiver) communicate directly rather than through a base station. For example, the first vehicle and the second vehicle directly transmit data via sidelink. In this case, it is necessary to determine the channel access priority class to ensure that different physical channels use different channel access priority classes, allowing different physical channels to access the unlicensed spectrum with different channel access parameters, thereby improving the utilization of the unlicensed spectrum.

In an embodiment, another application scenario may include:

In a smart home scenario, a mobile terminal communicates with a smart refrigerator via sidelink rather than through a base station. In this case, it is necessary to determine the channel access priority class to ensure that different physical channels use different channel access priority classes, allowing high-priority services to access the unlicensed spectrum first, thereby improving the utilization of the unlicensed spectrum.

In an embodiment, the network device communicates with multiple terminal devices simultaneously, thereby requiring channel contention. That is, the processing method of the present application is relatively more applicable in the downlink (compared to the uplink).

In an embodiment, when the terminal device executing the processing method of the embodiment of the present application is ready to transmit at least one of the Physical Sidelink Control Channel (PSCCH), the Physical Sidelink Shared Channel (PSSCH), or the Sidelink-Synchronization Signal/Physical Sidelink Broadcast Channel (S-SS/PSBCH), the transmitter needs to perform Type 1 channel access. Before performing Type 1 channel access, a channel access priority class needs to be preset or determined. Subsequently, parameters such as the defer duration, contention window size, and maximum Channel Occupancy Time (COT) are determined. That is, these parameters are associated with the channel access priority class (CAPC). Therefore, to determine parameters such as the defer duration, contention window size, and maximum COT, etc., the channel access priority class (preset channel access priority class) needs to be determined.

In an embodiment, as shown in Table 1 and Table 2, different CAPC tables are adopted for different physical channels by introducing a random backoff mechanism. Based on the different CAPC tables, in response to satisfying the preset condition, the channel is accessed with a preset CAPC.

In an embodiment, the random backoff mechanism defines four different CAPCes. Based on this, parameters such as the defer duration, contention window size, and maximum COT, etc., are determined.

In an embodiment, when the terminal device performs Type 1 channel access, the related parameters of the CAPC may be as shown in Table 1 and Table 2.

TABLE 1
CAPC

| CAPC | | | | | allowed CWₚ |
|---|---|---|---|---|---|
| (p) | mₚ | CW_{min, p} | CW_{max, p} | T_{m cot, p} | sizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |

In Table 1, p represents the CAPC; mp represents the defer parameter for CAPC p; CW_{min, p} represents the minimum contention window size for CAPC p; CW_{max, p} represents the maximum contention window size for CAPC p; T_{m cot, p} represents the maximum duration that CAPC p can occupy the frequency band after an LBT succeeds; and allowed CWₚ sizes represents the allowed contention window size for CAPC p.

TABLE 2
CAPC

| CAPC | | | | | allowed CWₚ |
|---|---|---|---|---|---|
| (p) | mₚ | CW_{min, p} | CW_{max, p} | T_{ulm cot, p} | sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | {15, 31, 63, 127, |
| | | | | | 255, 511, 1023} |

NOTE 1:
For p = 3, 4, T_{ulm cot, p} = 10 ms if the higher layer parameter absenceOfAnyOtherTechnology-r14 or absenceOfAnyOtherTechnology-r16 is provided, otherwise, T_{ulm cot, p} = 6 ms.
NOTE 2:
When T_{ulm cot, p} = 6 ms it may be increased to 8 ms by inserting one or more gaps. The minimum duration of a gap shall be 100 μs. The maximum duration before including any such gap shall be 6 ms.

In Table 2, p represents the CAPC; mₚ represents the defer parameter for CAPC p; CW_{min, p} represents the minimum contention window size for CAPC p; CW_{max, p} represents the maximum contention window size for CAPC p; T_{ulm cot, p} represents the maximum duration that CAPC p can occupy the frequency band after an LBT succeeds; and allowed CWₚ sizes represents the allowed contention window size (CWS) for CAPC p.

In an embodiment, the purpose of defining different CAPC for different physical channels is to enable high-priority services to use a small contention window size for faster channel access, while low-priority services use a large contention window size, thereby increasing the likelihood of transmitting high-priority data before low-priority data.

In an embodiment, each CAPC has a separate contention window size, and the maximum and minimum values of the contention window vary. Consequently, high-priority services can use a smaller contention window size for faster channel access, while low-priority services use a larger contention window size, thereby increasing the likelihood of transmitting high-priority data before low-priority data.

In an embodiment, the CAPC also determines the length of the defer duration. That is, when the transmitter performs Type 1 channel access, it senses the channel and waits until a certain frequency channel is idle for at least a period called the defer duration. This defer duration generally consists of a 16 μs plus several 9 μs sensing slots, and its length depends on the CAPC.

In an embodiment, in response to satisfying a preset condition, the channel is accessed with a preset CAPC.

In an embodiment, in response to different physical channels being transmitted, the channel is accessed with a preset CAPC.

In an embodiment, in response to different types of services being contained in the transmission channel, the channel is accessed with a preset CAPC.

In an embodiment, in response to different receivers, the channel is accessed with a preset CAPC.

In an embodiment, in response to different transmitters, the channel is accessed with a preset CAPC.

In an embodiment, in response to different channel priorities, the channel is accessed with a preset CAPC.

In an embodiment, in response to different physical channels being transmitted, the channel is accessed with a preset CAPC, including at least one of the following:
in response to that the transmitted physical channel includes at least two of the PSCCH, PSSCH, Physical Sidelink Feedback Channel (PSFCH), and S-SS/PSBCH, the channel is accessed with a corresponding preset CAPC; or
in response to that the transmitted physical channel includes more than two of the PSCCH, PSSCH, PSFCH, and S-SS/PSBCH, the channel is accessed with a corresponding preset CAPC.

In an embodiment, in response to different types of services being contained in the transmission channel, the channel is accessed with a preset CAPC, including:
in response to that the service types included in the transmission channel includes unicast, broadcast, and groupcast, the channel is accessed with a corresponding preset CAPC;
in response to that the service types included in the transmission channel includes unicast and broadcast, the channel is accessed with a corresponding preset CAPC;
in response to that the service types included in the transmission channel includes unicast and groupcast, the channel is accessed with a corresponding preset CAPC; and
in response to that the service types included in the transmission channel includes all of unicast, broadcast, and groupcast, the channel is accessed with a corresponding preset CAPC.

In an embodiment, in response to different receivers, the channel is accessed with a preset CAPC, including:
in response to that there are two different receivers, the channel is accessed with a corresponding preset CAPC; and
in response to that there are more than two different receivers, the channel is accessed with a corresponding preset CAPC.

In an embodiment, in response to different transmitters, the channel is accessed with a corresponding preset CAPC, including:
in response to that there are two different transmitters, the channel is accessed with a corresponding preset CAPC; and
in response to that there are more than two different transmitters, the channel is accessed with a corresponding preset CAPC.

In an embodiment, in response to different channel priorities, the channel is accessed with a preset CAPC, including:
in response to different priorities of the PSCCH, PSSCH, PSFCH, and S-SS/PSBCH, the channel is accessed with a corresponding preset CAPC.

In an embodiment, after determining that the preset condition is met, the channel is accessed with a preset CAPC.

In an embodiment, the CAPC needs to be preset or determined first.

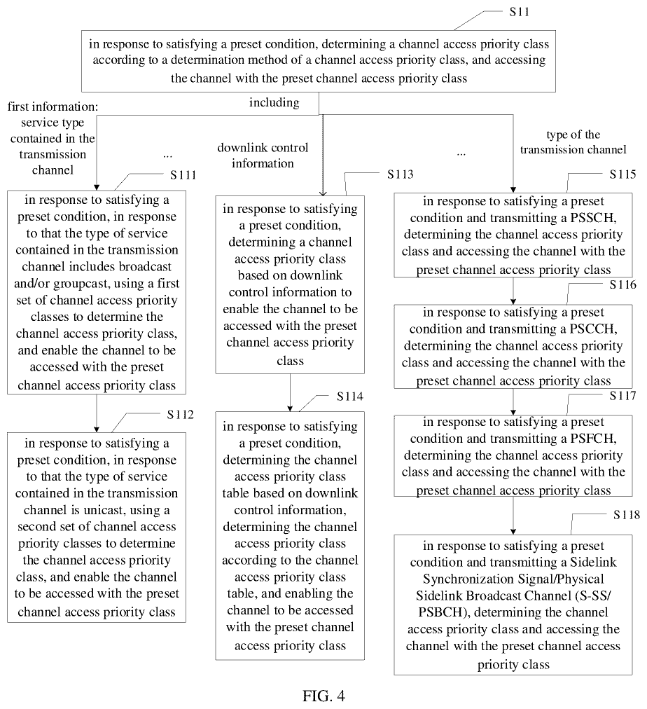

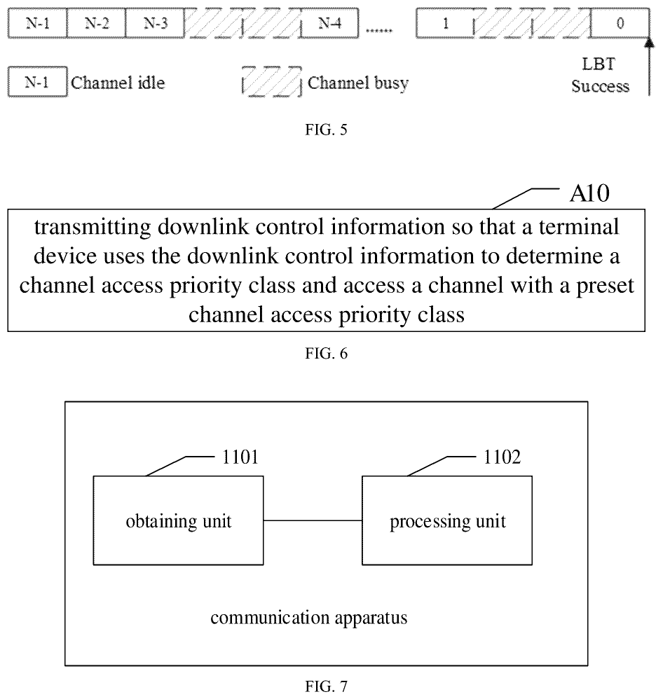

In an embodiment, as shown in FIG. 4, the processing method of the present application includes:
step S11, in response to satisfying a preset condition, determining a CAPC according to a determination method of a CAPC, and accessing the channel with the preset CAPC.

In an embodiment, the determination method of the CAPC includes:
determining the CAPC according to the type of service contained in the transmission channel;
in an embodiment, the type of service contained in the transmission channel includes broadcast and/or groupcast.

In an embodiment, the type of service contained in the transmission channel includes unicast.

In an embodiment, the type of service contained in the transmission channel includes broadcast and unicast, groupcast and unicast, or broadcast, groupcast, and unicast.

In an embodiment, the determination method of the CAPC includes: determining the CAPC based on downlink control information, thereby enabling the channel to be accessed with a preset CAPC.

In an embodiment, the determination method of the CAPC includes: determining the CAPC based on the type of the transmission channel, thereby enabling the channel to be accessed with a preset CAPC.

In an embodiment, the type of transmission channel includes at least one of PSCCH, PSSCH, and S-SS/PSBCH.

In an embodiment, as shown in FIG. 4, the method further includes at least one of the following.

Step S115, in response to satisfying a preset condition and transmitting a PSSCH, determining the CAPC and accessing the channel with the preset CAPC.

Step S116, in response to satisfying a preset condition and transmitting a PSCCH, determining the CAPC and accessing the channel with the preset CAPC.

Step S117, in response to satisfying a preset condition and transmitting a PSFCH, determining the CAPC and accessing the channel with the preset CAPC.

Step S118, in response to satisfying a preset condition and transmitting a S-SS/PSBCH, determining the CAPC and accessing the channel with the preset CAPC.

In an embodiment, the CAPC is determined according to the logical channel corresponding to the PSSCH, and in response to satisfying a preset condition, the channel is accessed with the preset CAPC.

In an embodiment, the logical channel corresponding to the PSSCH may be a voice service channel or a data service channel, with no specific limitation.

In an embodiment, the CAPC is determined based on the receiver identifier of the PSSCH, thereby enabling the channel to be accessed with the preset CAPC.

In an embodiment, a first preset association exists between the receiver identifier and the CAPC.

In an embodiment, the CAPC is determined based on the transmitter identifier of the PSSCH, thereby enabling the channel to be accessed with the preset CAPC.

In an embodiment, a second preset association exists between the transmitter identifier and the CAPC.

In an embodiment, the CAPC is jointly determined based on the receiver identifier and the transmitter identifier of the PSSCH, thereby enabling the channel to be accessed with the preset CAPC.

A third preset association exists between the receiver identifier, the transmitter identifier, and the CAPC.

In an embodiment, the CAPC is determined based on the number of receivers, thereby enabling the channel to be accessed with the preset CAPC.

In an embodiment, the number of receivers is inversely proportional to the CAPC. That is, as the number of receivers increases, the CAPC decreases.

In an embodiment, if the number of receivers is greater than one, the CAPC is determined based on the lowest priority among the receivers.

In an embodiment, if the number of receivers is greater than one, the CAPC is determined based on the highest priority among the receivers.

In an embodiment, if the number of receivers is greater than one, the CAPC is determined based on the priority of a randomly selected receiver.

In an embodiment, the priority is a PC5 5G QOS Identifier (PC5 5QI), thereby enabling the channel to be accessed with the preset CAPC.

In an embodiment, a mapping relationship exists between the PC5 5G QoS Identifier value and the CAPC.

In an embodiment, a mapping relationship exists between the PC5 5G QoS Identifier value and the resource type, such as: delay Critical GBR corresponds to CAPC 1 and/or class 2. GBR corresponds to CAPC 2 and/or class 3; and/or, non-GBR corresponds to CAPC 3 and/or class 4, etc.

In an embodiment, a mapping relationship exists between the PC5 5G QoS Identifier value and the default priority level, such as: default priority level 2 corresponds to CAPC 1 and/or class 2; and/or, default priority level 3 corresponds to CAPC 2 and/or class 3; and/or, default priority levels 4, 5, and 6 correspond to CAPC 3 and/or class 4.

In an embodiment, a mapping relationship exists between the PC5 5G QoS Identifier value and the packet error rate, such as: a packet error rate of 10⁻⁵ corresponds to CAPC 1 and/or class 2; and/or, a packet error rate of 10⁻⁴ corresponds to CAPC 2 and/or class 3; and/or, a packet error rate of 10⁻² corresponds to CAPC 3 and/or class 4; and/or, a packet error rate of 10⁻¹ corresponds to CAPC 4.

In an embodiment, a mapping relationship exists between the PC5 5G QoS Identifier value and the packet delay budget, such as: a packet delay budget of 3 ms corresponds to CAPC 1; and/or, a packet delay budget of 10 ms corresponds to CAPC 1 and/or class 2; and/or, a packet delay budget of 20 ms or 25 ms corresponds to CAPC 2 and/or class 3; and/or, a packet delay budget of 50 ms or 100 ms corresponds to CAPC 3 and/or class 4; and/or, a packet delay budget of 500 ms corresponds to CAPC 4, etc.

In an embodiment, the CAPC is determined according to the per-packet priority (PPPP) of Near Field Communication (NFC), thereby enabling the channel to be accessed with the preset CAPC.

In an embodiment, the CAPC can be determined by any one or a combination of the following factors: the type of service contained in the transmission channel, downlink control information, the type of the transmission channel, the logical channel corresponding to the PSSCH, the receiver identifier of the PSSCH, the transmitter identifier of the PSSCH, the combination of receiver and transmitter identifiers, the number of receivers, or the per-packet priority (PPPP) of Near Field Communication.

In an embodiment, the CAPC can be jointly determined based on both the type of service contained in the transmission channel and the downlink control information. In an embodiment, the CAPC can be determined based on the type of service contained in the transmission channel, downlink control information, and the number of receivers.

In an embodiment, as shown in FIG. 4, step S11 further includes at least one of the following:

Step S111: in response to satisfying a preset condition, in response to that the type of service contained in the transmission channel includes broadcast and/or groupcast, using a first set CAPC to determine the CAPC, and enable the channel to be accessed with the preset CAPC.

Step S112: in response to satisfying a preset condition, in response to that the type of service contained in the transmission channel is unicast, using a second set CAPC to determine the CAPC, and enable the channel to be accessed with the preset CAPC.

In an embodiment, in response to that the type of service contained in the transmission channel includes broadcast and/or groupcast, Table 1 is used to determine the CAPC, i.e., the first set CAPC corresponds to Table 1. Subsequently, in response to satisfying the preset condition, the channel is accessed with the preset CAPC.

In an embodiment, after determining the CAPC using Table 1, the first decision rule is applied to determine the specific CAPC p according to the CAPC table, thereby enabling the channel to be accessed with the preset CAPC and further determining parameters such as the defer duration, contention window size, and maximum COT, etc.

In an embodiment, the first decision rule includes determining the CAPC p based on the logical channel corresponding to the PSSCH. For example, for voice services, the CAPC p is 1. In an embodiment, the first decision rule further includes determining the CAPC p based on the receiver identifier of the PSSCH, such as the destination identifier. In an embodiment, the first decision rule further includes determining the CAPC p based on the transmitter identifier of the PSSCH, such as the source identifier. In an embodiment, the first decision rule further includes jointly determining the CAPC p based on the receiver and transmitter identifiers of the PSSCH. For example, the first decision rule selects the lower priority class between the receiver and transmitter identifiers. In an embodiment, the first decision rule further includes selecting the higher priority class between the receiver and transmitter identifiers to determine the CAPC p. In an embodiment, if the number of receivers is greater than one, the first decision rule selects the lowest priority among the receivers to determine the CAPC p. In an embodiment, if the number of receivers is greater than one, the first decision rule selects the highest priority among the receivers to determine the CAPC p. In an embodiment, if the number of receivers is greater than one, the first decision rule randomly selects a receiver and determines the CAPC p based on its priority. In an embodiment, the priority is a PC5 5G QOS Identifier (PQI). In an embodiment, a mapping relationship exists between the priority class p and the per-packet priority (PPPP) of Near Field Communication. In an embodiment, the priority is determined based on the per-packet priority (PPPP, ProSe per-packet priority) of Near Field Communication, which is provided by the higher layer to the physical layer. After determining the CAPC p, Table 1 is used to determine parameters such as the defer duration, contention window size, and maximum COT, etc.

In an embodiment, the first decision rule includes determining the CAPC p based on downlink control information, thereby determining parameters such as the defer duration, contention window size, and maximum COT, etc. In an embodiment, the CAPC p is determined based on bit field in the downlink control information, thereby determining parameters such as the defer duration, contention window size, and maximum COT, etc. In an embodiment, the CAPC p is determined based on newly added column information in the table indicated by the downlink control information, thereby determining parameters such as the defer duration, contention window size, and maximum COT, etc. In an embodiment, the CAPC p is determined based on newly added index information in the table indicated by the downlink control information, thereby determining parameters such as the defer duration, contention window size, and maximum COT, etc. In an embodiment, the CAPC p indicated by the downlink control information is configured based on RRC signaling.

In an embodiment, if the type of service contained in the transmission channel is broadcast and/or groupcast, Table 1 is used exclusively to determine the CAPC, ensuring high-priority services have prioritized access to the unlicensed spectrum, thereby improving the utilization of the unlicensed spectrum.

In an embodiment, if the type of service contained in the transmission channel is unicast, the second set CAPC is used to determine the CAPC.

If the type of service contained in the transmission channel includes unicast, Table 2 is used to determine the CAPC, i.e., the second set CAPC corresponds to Table 2.

In an embodiment, after determining the CAPC using Table 2, the second decision rule is applied to determine the specific CAPC p according to the CAPC table, thereby enabling the channel to be accessed with the preset CAPC and further determining parameters such as the defer duration, contention window size, and maximum COT, etc.

In an embodiment, the second decision rule includes determining the CAPC p based on the logical channel corresponding to the PSSCH. For example, for voice services, the CAPC p is 1. In an embodiment, the second decision rule further includes the transmitter determining the CAPC p based on the receiver identifier of the PSSCH, such as the destination identifier. In an embodiment, the second decision rule further includes the transmitter determining the CAPC p based on the transmitter identifier of the PSSCH, such as the source identifier. In an embodiment, the second decision rule further includes the transmitter jointly determining the CAPC p based on the receiver and transmitter identifiers of the PSSCH. For example, the second decision rule selects the lower priority class between the receiver and transmitter identifiers. In an embodiment, the second decision rule further includes the transmitter jointly determining the CAPC p based on the receiver and transmitter identifiers of the PSSCH. For example, the second decision rule further includes selecting the higher priority class between the receiver and transmitter identifiers to determine the CAPC p.

In an embodiment, if the number of receivers is greater than one, the second decision rule selects the lowest priority among the receivers to determine the CAPC p, thereby enabling the channel to be accessed with the preset CAPC.

In an embodiment, if the number of receivers is greater than one, the second decision rule selects the highest priority among the receivers to determine the CAPC p, thereby enabling the channel to be accessed with the preset CAPC.

In an embodiment, if the number of receivers is greater than one, the second decision rule randomly selects a receiver and determines the CAPC p based on its priority, thereby enabling the channel to be accessed with the preset CAPC.

In an embodiment, the priority is a PC5 5G QOS Identifier (PQI).

In an embodiment, a mapping relationship exists between the priority class p and the per-packet priority (PPPP) of Near Field Communication.

In an embodiment, the priority is determined based on the per-packet priority (PPPP, ProSe per-packet priority) of Near Field Communication, which is provided by the higher layer to the physical layer. After determining the CAPC p, Table 2 is used to determine parameters such as the defer duration, contention window size, and maximum COT, etc.

In an embodiment, the second decision rule includes determining the CAPC p based on downlink control information, thereby enabling the channel to be accessed with the preset CAPC and further determining parameters such as the defer duration, contention window size, and maximum COT, etc.

In an embodiment, the CAPC p is determined based on bit field in the downlink control information, thereby enabling the channel to be accessed with the preset CAPC and further determining parameters such as the defer duration, contention window size, and maximum COT, etc.

In an embodiment, the CAPC p is determined based on newly added column information in the table indicated by the downlink control information, thereby enabling the channel to be accessed with the preset CAPC and further determining parameters such as the defer duration, contention window size, and maximum COT, etc.

In an embodiment, the CAPC p is determined based on newly added index information in the table indicated by the downlink control information, thereby enabling the channel to be accessed with the preset CAPC and further determining parameters such as the defer duration, contention window size, and maximum COT, etc.

In an embodiment, the CAPC p indicated by the downlink control information is configured based on RRC signaling, thereby enabling the channel to be accessed with the preset CAPC and further determining parameters such as the defer duration, contention window size, and maximum COT, etc.

In an embodiment, if the type of service contained in the transmission channel is unicast, Table 2 is used exclusively to determine the CAPC, and the channel is subsequently accessed with the preset CAPC, ensuring that low-priority services access the unlicensed spectrum later, thereby improving the utilization of the unlicensed spectrum.

In an embodiment, the method further includes at least one of the following.

The first set CAPC and the second set CAPC belong to different CAPC tables.

The first set CAPC and the second set CAPC belong to different elements of the same CAPC table.

In an embodiment, if the first set CAPC belongs to Table 1 and the second set CAPC belongs to Table 2, then they belong to different CAPC tables. Since they are in different CAPC tables, the efficiency of determining the CAPC is improved, thereby enabling the channel to be accessed with the preset CAPC.

In an embodiment, if the first set CAPC and the second set CAPC belong to different elements within the same CAPC table, as shown in Table 3, then the first four rows in Table 3 belong to the first set CAPC, while the last four rows belong to the second set CAPC.

Since both sets belong to the same CAPC table, table resources for storing CAPCes can be optimized, thereby enabling the channel to be accessed with the preset CAPC.

TABLE 3
CAPC

| CAPC | | | | | |
|---|---|---|---|---|---|
| (p) | mₚ | CW_{min, p} | CW_{max, p} | T_{m cot, p} | allowed CWₚsizes |
| 1 | 1 | 3 | 7 | 2 ms | (3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | 15, 31, 63, 127, |
| | | | | | 255, 511, 1023} |
| 5 | 2 | 3 | 7 | 2 ms | {3, 7} |
| 6 | 2 | 7 | 15 | 4 ms | {7, 15} |
| 7 | 3 | 15 | 1023 | 6 ms or 10 ms | {15, 31, 63, 127, |
| | | | | | 255, 511, 1023} |
| 8 | 7 | 15 | 1023 | 6 ms or 10 ms | {15, 31, 63, 127, |
| | | | | | 255, 511, 1023} |

In an embodiment, the method further includes:

Step S20: determining at least one parameter of the defer duration, the allowed contention window size, or the maximum COT.

In an embodiment, after accessing the channel with the preset CAPC in response to satisfying the preset condition, at least one parameter of the defer duration, the allowed contention window size, or the maximum COT is determined.

In an embodiment, after determining the CAPC table, the CAPC is determined according to the corresponding table, thereby enabling the channel to be accessed with the preset CAPC, and subsequently determining at least one parameter of the defer duration, the allowed contention window size, or the maximum COT.

As described above, the processing method of the present application enables the channel to be accessed with the preset CAPC in response to satisfying a preset condition. Since the present application explicitly defines CAPCes in the SL-U system, different physical channels can use different CAPCes, ensuring that different physical channels access the unlicensed spectrum using different channel access parameters, thereby improving the utilization of the unlicensed spectrum.

In an embodiment, as shown in FIG. 4, the method of the present application may include:
step S113: in response to satisfying a preset condition, determining a CAPC based on downlink control information to enable the channel to be accessed with the preset CAPC.

In an embodiment, when the terminal device executing the processing method of the present application is preparing to transmit at least one of the PSCCH, the PSSCH, or the S-SS/PSBCH, the transmitter needs to perform Type 1 channel access. Before performing Type 1 channel access, a CAPC needs to be either preset or determined, which then determines the parameters such as defer duration, contention window size, and maximum COT, etc. These parameters are associated with the CAPC. Therefore, to determine parameters such as the defer duration, contention window size, and maximum COT, etc., the CAPC must first be determined.

In an embodiment, the transmitter determines the CAPC based on downlink control information, thereby enabling the channel to be accessed with the preset CAPC, and subsequently determining at least one parameter of the defer duration, the allowed contention window size, or the maximum COT.

In an embodiment, the downlink control information determines the CAPC according to Table 4, which is configured via RRC signaling. Consequently, the channel is accessed with the preset CAPC, and at least one parameter of the defer duration, the allowed contention window size, or the maximum COT is determined.

In an embodiment, the CAPC can be determined directly through downlink control information, thereby enabling the channel to be accessed with the preset CAPC without requiring multiple determination steps. This improves the efficiency of determining the CAPC.

TABLE 4

| | | The CP | |
|---|---|---|---|
| | | extension | |
| | | T_“ext” | |
| | | index defined | |
| | | in Clause | |
| Entry | | 5.3.1 of | |
| index | Channel Access Type | [4, 38.211] | CAPC |
| 0 | Type2C-ULChannelAccess defined in | 0 | 1 |
| | [clause 4.2.1.2.3 in 37.213] | | |
| 1 | Type2C-ULChannelAccess defined in | 0 | 2 |
| | [clause 4.2.1.2.3 in 37.213] | | |
| 2 | Type2C-ULChannelAccess defined in | 0 | 3 |
| | [clause 4.2.1.2.3 in 37.213] | | |
| 3 | Type2C-ULChannelAccess defined in | 0 | 4 |
| | [clause 4.2.1.2.3 in 37.213] | | |
| 4 | Type2C-ULChannelAccess defined in | 2 | 1 |
| | [clause 4.2.1.2.3 in 37.213] | | |
| 5 | Type2C-ULChannelAccess defined in | 2 | 2 |
| | [clause 4.2.1.2.3 in 37.213] | | |
| 6 | Type2C-ULChannelAccess defined in | 2 | 3 |
| | [clause 4.2.1.2.3 in 37.213] | | |
| 7 | Type2C-ULChannelAccess defined in | 2 | 4 |
| | [clause 4.2.1.2.3 in 37.213] | | |
| 8 | Type2B-ULChannelAccess defined in | 0 | 1 |
| | [clause 4.2.1.2.2 in 37.213] | | |
| 9 | Type2B-ULChannelAccess defined in | 0 | 2 |
| | [clause 4.2.1.2.2 in 37.213] | | |
| 10 | Type2B-ULChannelAccess defined in | 0 | 3 |
| | [clause 4.2.1.2.2 in 37.213] | | |
| 11 | Type2B-ULChannelAccess defined in | 0 | 4 |
| | [clause 4.2.1.2.2 in 37.213] | | |
| 12 | Type2B-ULChannelAccess defined in | 2 | 1 |
| | [clause 4.2.1.2.2 in 37.213] | | |
| 13 | Type2B-ULChannelAccess defined in | 2 | 2 |
| | [clause 4.2.1.2.2 in 37.213] | | |
| 14 | Type2B-ULChannelAccess defined in | 2 | 3 |
| | [clause 4.2.1.2.2 in 37.213] | | |
| 15 | Type2B-ULChannelAccess defined in | 2 | 4 |
| | [clause 4.2.1.2.2 in 37.213] | | |
| 16 | Type2A-ULChannelAccess defined in | 0 | 1 |
| | [clause 4.2.1.2.1 in 37.213] | | |
| 17 | Type2A-ULChannelAccess defined in | 0 | 2 |
| | [clause 4.2.1.2.1 in 37.213] | | |
| 18 | Type2A-ULChannelAccess defined in | 0 | 3 |
| | [clause 4.2.1.2.1 in 37.213] | | |
| 19 | Type2A-ULChannelAccess defined in | 0 | 4 |
| | [clause 4.2.1.2.1 in 37.213] | | |
| 20 | Type2A-ULChannelAccess defined in | 1 | 1 |
| | [clause 4.2.1.2.1 in 37.213] | | |
| 21 | Type2A-ULChannelAccess defined in | 1 | 2 |
| | [clause 4.2.1.2.1 in 37.213] | | |
| 22 | Type2A-ULChannelAccess defined in | 1 | 3 |
| | [clause 4.2.1.2.1 in 37.213] | | |
| 23 | Type2A-ULChannelAccess defined in | 1 | 4 |
| | [clause 4.2.1.2.1 in 37.213] | | |
| 24 | Type2A-ULChannelAccess defined in | 3 | 1 |
| | [clause 4.2.1.2.1 in 37.213] | | |
| 25 | Type2A-ULChannelAccess defined in | 3 | 2 |
| | [clause 4.2.1.2.1 in 37.213] | | |
| 26 | Type2A-ULChannelAccess defined in | 3 | 3 |
| | [clause 4.2.1.2.1 in 37.213] | | |
| 27 | Type2A-ULChannelAccess defined in | 3 | 4 |
| | [clause 4.2.1.2.1 in 37.213] | | |
| 28 | Type1-ULChannelAccess defined in | 0 | 1 |
| | [clause 4.2.1.1 in 37.213] | | |
| 29 | Type1-ULChannelAccess defined in | 0 | 2 |
| | [clause 4.2.1.1 in 37.213] | | |
| 30 | Type1-ULChannelAccess defined in | 0 | 3 |
| | [clause 4.2.1.1 in 37.213] | | |
| 31 | Type1-ULChannelAccess defined in | 0 | 4 |
| | [clause 4.2.1.1 in 37.213] | | |
| 32 | Type1-ULChannelAccess defined in | 1 | 1 |
| | [clause 4.2.1.1 in 37.213] | | |
| 33 | Type1-ULChannelAccess defined in | 1 | 2 |
| | [clause 4.2.1.1 in 37.213] | | |
| 34 | Type1-ULChannelAccess defined in | 1 | 3 |
| | [clause 4.2.1.1 in 37.213] | | |
| 35 | Type1-ULChannelAccess defined in | 1 | 4 |
| | [clause 4.2.1.1 in 37.213] | | |
| 36 | Type1-ULChannelAccess defined in | 2 | 1 |
| | [clause 4.2.1.1 in 37.213] | | |
| 37 | Type1-ULChannelAccess defined in | 2 | 2 |
| | [clause 4.2.1.1 in 37.213] | | |
| 38 | Type1-ULChannelAccess defined in | 2 | 3 |
| | [clause 4.2.1.1 in 37.213] | | |
| 39 | Type1-ULChannelAccess defined in | 2 | 4 |
| | [clause 4.2.1.1 in 37.213] | | |
| 40 | Type1-ULChannelAccess defined in | 3 | 1 |
| | [clause 4.2.1.1 in 37.213] | | |
| 41 | Type1-ULChannelAccess defined in | 3 | 2 |
| | [clause 4.2.1.1 in 37.213] | | |
| 42 | Type1-ULChannelAccess defined in | 3 | 3 |
| | [clause 4.2.1.1 in 37.213] | | |
| 43 | Type1-ULChannelAccess defined in | 3 | 4 |
| | [clause 4.2.1.1 in 37.213] | | |

In Table 4, “Entry index” refers to the index of the entry. “Channel Access Type” refers to the type of channel access. “Type1-ULChannelAccess defined in [clause 4.2.1.1 in 37.213]” refers to Type 1 UL channel access as defined in Clause 4.2.1.1 of 37.213. “Type2A-ULChannelAccess defined in [clause 4.2.1.2.1 in 37.213]” refers to Type 2A UL channel access as defined in Clause 4.2.1.2.1 of 37.213. “Type2B-ULChannelAccess defined in [clause 4.2.1.2.1 in 37.213]” refers to Type 2B UL channel access as defined in Clause 4.2.1.2.1 of 37.213. “Type2C-ULChannelAccess defined in [clause 4.2.1.2.1 in 37.213]” refers to Type 2C UL channel access as defined in Clause 4.2.1.2.1 of 37.213. These definitions specify the different CAPCes (CAPC) applicable to different physical channels. “The CP extension T ‘ext’ index defined in Clause 5.3.1 of [4, 38.211]” refers to the extended index definition in Clause 5.3.1 of [4, 38.211].

In an embodiment, as shown in Table 4, Type 1 UL channel access is defined in Clause 4.2.1.1 of 37.213, and the specific CAPC is determined according to the fourth column of Table 4.

In an embodiment, the CAPC is indicated directly based on bit field in the downlink control information or based on newly added index information in the table indicated by the downlink control information, thereby directly specifying the corresponding target row in the fourth column of Table 4.

In an embodiment, the CAPC is determined based on a combination of the downlink control information and other information, thereby specifying the corresponding target row in the fourth column of Table 4.

In an embodiment, the CAPC is determined based on a combination of downlink control information and the type of service contained in the transmission channel. The determined CAPC is then indicated in the fourth column of Table 4, thereby enabling the channel to be accessed with the preset CAPC.

In an embodiment, the CAPC is determined based on a combination of downlink control information and the receiver identifier of the PSSCH. The determined CAPC is then indicated in the fourth column of Table 4, thereby enabling the channel to be accessed with the preset CAPC.

In an embodiment, the CAPC is determined based on other parameters and indicated directly in the fourth column of Table 4, thereby enabling the channel to be accessed with the preset CAPC.

In an embodiment, after determining the target row, i.e., the CAPC, the channel is accessed with the preset CAPC, and parameters such as the defer duration, contention window size, and maximum COT, etc., are subsequently determined.

As described above, the processing method of the present application enables the channel to be accessed with the preset CAPC in response to satisfying a preset condition. The technical solution of the present application facilitates the determination of the CAPC based on downlink control information, thereby enabling different physical channels to use different CAPCes and ensuring that different physical channels access the unlicensed spectrum using different channel access parameters. This enhances the utilization of the unlicensed spectrum.

In an embodiment, the processing method of the present application may include:
in response to satisfying a preset condition, determining a CAPC table based on downlink control information, then determining the CAPC according to the CAPC table, thereby enabling the channel to be accessed with the preset CAPC.

In an embodiment, when the terminal device executing the processing method of the present application is preparing to transmit at least one of the PSCCH, the PSSCH, or the S-SS/PSBCH, the transmitter needs to perform Type 1 channel access. Before performing Type 1 channel access, a CAPC needs to be either preset or determined, which then determines the defer duration, contention window size, and maximum COT. These parameters are associated with the CAPC. Therefore, to determine parameters such as the defer duration, contention window size, and maximum COT, etc., the CAPC must first be determined.

In an embodiment, the transmitter determines the CAPC table based on downlink control information, then determines the CAPC according to the CAPC table. The channel is subsequently accessed with the preset CAPC, and parameters such as the defer duration, contention window size, and maximum COT, etc., are determined.

In an embodiment, the table indicated by the downlink control information is configured based on RRC signaling. Additionally, determining the CAPC table based on downlink control information further includes at least one of the following:

Determining the CAPC table based on bit field in the downlink control information.

Determining the CAPC table based on newly added column information in the table indicated by the downlink control information.

Determining the CAPC table based on newly added index information in the table indicated by the downlink control information.

In an embodiment, an additional 1-bit field is added to the downlink control information to indicate whether the CAPC table is Table 1 or Table 2, as shown in Table 5.

In an embodiment, an additional column is added to the table indicated by the downlink control information to specify the CAPC table. For example, in Table 5, the “table” column is the newly added fifth column. If the column value is 1, the CAPC table is Table 1; and if the column value is 2, the CAPC table is Table 2.

In an embodiment, by combining the fourth and fifth columns of Table 5, the corresponding CAPC for each row can be determined. This specifies which table and which CAPC should be used, thereby enabling the channel to be accessed with the preset CAPC.

In an embodiment, after determining the CAPC table based on newly added index information in the table indicated by the downlink control information, the channel is accessed with the preset CAPC.

In an embodiment, the number of rows in the table is increased to distinguish different CAPCes. For example, if the first 43 rows indicate that the CAPC table is Table 1, and the last 43 rows indicate that the CAPC table is Table 2.

In an embodiment, the table indicated by the downlink control information is configured based on RRC signaling. In an embodiment, the RRC signaling configuration is determined based on higher-layer settings, thereby enabling the channel to be accessed with the preset CAPC.

In an embodiment, after determining the CAPC table, the third decision rule is applied to determine the CAPC, thereby enabling the channel to be accessed with the preset CAPC.

In an embodiment, the third decision rule includes determining the CAPC p based on the logical channel corresponding to the PSSCH. For example, for voice services, the CAPC p is 1. In an embodiment, the third decision rule further includes determining the CAPC p based on the receiver identifier of the PSSCH, such as the destination identifier. In an embodiment, the third decision rule further includes determining the CAPC p based on the transmitter identifier of the PSSCH, such as the source identifier. In an embodiment, the third decision rule further includes jointly determining the CAPC p based on the receiver and transmitter identifiers of the PSSCH. For example, the third decision rule selects the lower priority class between the receiver and transmitter identifiers. In an embodiment, the third decision rule further includes selecting the higher priority class between the receiver and transmitter identifiers to determine the CAPC p. In an embodiment, if the number of receivers is greater than one, the third decision rule selects the lowest priority among the receivers to determine the CAPC p, thereby enabling the channel to be accessed with the preset CAPC. In an embodiment, if the number of receivers is greater than one, the third decision rule selects the highest priority among the receivers to determine the CAPC p, thereby enabling the channel to be accessed with the preset CAPC. In an embodiment, if the number of receivers is greater than one, the third decision rule randomly selects a receiver and determines the CAPC p based on its priority, thereby enabling the channel to be accessed with the preset CAPC. In an embodiment, the priority is a PC5 5G QOS Identifier (PQI), thereby enabling the channel to be accessed with the preset CAPC. In an embodiment, a mapping relationship exists between the priority class p and the per-packet priority (PPPP) of Near Field Communication, thereby enabling the channel to be accessed with the preset CAPC. In an embodiment, the priority is determined based on the per-packet priority (PPPP, ProSe per-packet priority) of Near Field Communication, which is provided by the higher layer to the physical layer. After determining the CAPC p, the channel is accessed with the preset CAPC, and Table 1 is subsequently used to determine parameters such as the defer duration, contention window size, and maximum COT, etc.

In an embodiment, the third decision rule includes determining the CAPC p based on downlink control information, thereby enabling the channel to be accessed with the preset CAPC, and subsequently determining parameters such as the defer duration, contention window size, and maximum COT, etc. In an embodiment, the CAPC p is determined based on bit field in the downlink control information, thereby enabling the channel to be accessed with the preset CAPC, and subsequently determining parameters such as the defer duration, contention window size, and maximum COT, etc. In an embodiment, the CAPC p is determined based on newly added column information in the table indicated by the downlink control information, thereby enabling the channel to be accessed with the preset CAPC, and subsequently determining parameters such as the defer duration, contention window size, and maximum COT, etc. In an embodiment, the CAPC p is determined based on newly added index information in the table indicated by the downlink control information, thereby enabling the channel to be accessed with the preset CAPC, and subsequently determining parameters such as the defer duration, contention window size, and maximum COT, etc. In an embodiment, the CAPC p indicated by the downlink control information is configured based on RRC signaling.

TABLE 5

| | | The CP extension | | |
|---|---|---|---|---|
| | | T_“ext” | | |
| | | index defined in | | |
| Entry | | Clause 5.3.1 of | | |
| index | Channel Access Type | [4, 38.211] | CAPC | Table |
| 0 | Type2C-ULChannelAccess defined in | 0 | 1 | 1 |
| | [clause 4.2.1.2.3 in 37.213] | | | |
| 1 | Type2C-ULChannelAccess defined in | 0 | 2 | 1 |
| | [clause 4.2.1.2.3 in 37.213] | | | |
| 2 | Type2C-ULChannelAccess defined in | 0 | 3 | 1 |
| | [clause 4.2.1.2.3 in 37.213] | | | |
| 3 | Type2C-ULChannelAccess defined in | 0 | 4 | 1 |
| | [clause 4.2.1.2.3 in 37.213] | | | |
| 4 | Type2C-ULChannelAccess defined in | 2 | 1 | 2 |
| | [clause 4.2.1.2.3 in 37.213] | | | |
| 5 | Type2C-ULChannelAccess defined in | 2 | 2 | 2 |
| | [clause 4.2.1.2.3 in 37.213] | | | |
| 6 | Type2C-ULChannelAccess defined in | 2 | 3 | 2 |
| | [clause 4.2.1.2.3 in 37.213] | | | |
| 7 | Type2C-ULChannelAccess defined in | 2 | 4 | 2 |
| | [clause 4.2.1.2.3 in 37.213] | | | |
| 8 | Type2B-ULChannelAccess defined in | 0 | 1 | 1 |
| | [clause 4.2.1.2.2 in 37.213] | | | |
| 9 | Type2B-ULChannelAccess defined in | 0 | 2 | 1 |
| | [clause 4.2.1.2.2 in 37.213] | | | |
| 10 | Type2B-ULChannelAccess defined in | 0 | 3 | 2 |
| | [clause 4.2.1.2.2 in 37.213] | | | |
| 11 | Type2B-ULChannelAccess defined in | 0 | 4 | 2 |
| | [clause 4.2.1.2.2 in 37.213] | | | |
| 12 | Type2B-ULChannelAccess defined in | 2 | 1 | 1 |
| | [clause 4.2.1.2.2 in 37.213] | | | |
| 13 | Type2B-ULChannelAccess defined in | 2 | 2 | 1 |
| | [clause 4.2.1.2.2 in 37.213] | | | |
| 14 | Type2B-ULChannelAccess defined in | 2 | 3 | 1 |
| | [clause 4.2.1.2.2 in 37.213] | | | |
| 15 | Type2B-ULChannelAccess defined in | 2 | 4 | 1 |
| | [clause 4.2.1.2.2 in 37.213] | | | |
| 16 | Type2A-ULChannelAccess defined in | 0 | 1 | 2 |
| | [clause 4.2.1.2.1 in 37.213] | | | |
| 17 | Type2A-ULChannelAccess defined in | 0 | 2 | 2 |
| | [clause 4.2.1.2.1 in 37.213] | | | |
| 18 | Type2A-ULChannelAccess defined in | 0 | 3 | 2 |
| | [clause 4.2.1.2.1 in 37.213] | | | |
| 19 | Type2A-ULChannelAccess defined in | 0 | 4 | 2 |
| | [clause 4.2.1.2.1 in 37.213] | | | |
| 20 | Type2A-ULChannelAccess defined in | 1 | 1 | 1 |
| | [clause 4.2.1.2.1 in 37.213] | | | |
| 21 | Type2A-ULChannelAccess defined in | 1 | 2 | 1 |
| | [clause 4.2.1.2.1 in 37.213] | | | |
| 22 | Type2A-ULChannelAccess defined in | 1 | 3 | 1 |
| | [clause 4.2.1.2.1 in 37.213] | | | |
| 23 | Type2A-ULChannelAccess defined in | 1 | 4 | 1 |
| | [clause 4.2.1.2.1 in 37.213] | | | |
| 24 | Type2A-ULChannelAccess defined in | 3 | 1 | 2 |
| | [clause 4.2.1.2.1 in 37.213] | | | |
| 25 | Type2A-ULChannelAccess defined in | 3 | 2 | 2 |
| | [clause 4.2.1.2.1 in 37.213] | | | |
| 26 | Type2A-ULChannelAccess defined in | 3 | 3 | 2 |
| | [clause 4.2.1.2.1 in 37.213] | | | |
| 27 | Type2A-ULChannelAccess defined in | 3 | 4 | 2 |
| | [clause 4.2.1.2.1 in 37.213] | | | |
| 28 | Type1-ULChannelAccess defined in | 0 | 1 | 1 |
| | [clause 4.2.1.1 in 37.213] | | | |
| 29 | Type1-ULChannelAccess defined in | 0 | 2 | 1 |
| | [clause 4.2.1.1 in 37.213] | | | |
| 30 | Type1-ULChannelAccess defined in | 0 | 3 | 2 |
| | [clause 4.2.1.1 in 37.213] | | | |
| 31 | Type1-ULChannelAccess defined in | 0 | 4 | 2 |
| | [clause 4.2.1.1 in 37.213] | | | |
| 32 | Type1-ULChannelAccess defined in | 1 | 1 | 2 |
| | [clause 4.2.1.1 in 37.213] | | | |
| 33 | Type1-ULChannelAccess defined in | 1 | 2 | 2 |
| | [clause 4.2.1.1 in 37.213] | | | |
| 34 | Type1-ULChannelAccess defined in | 1 | 3 | 2 |
| | [clause 4.2.1.1 in 37.213] | | | |
| 35 | Type1-ULChannelAccess defined in | 1 | 4 | 2 |
| | [clause 4.2.1.1 in 37.213] | | | |
| 36 | Type1-ULChannelAccess defined in | 2 | 1 | 1 |
| | [clause 4.2.1.1 in 37.213] | | | |
| 37 | Type1-ULChannelAccess defined in | 2 | 2 | 1 |
| | [clause 4.2.1.1 in 37.213] | | | |
| 38 | Type1-ULChannelAccess defined in | 2 | 3 | 2 |
| | [clause 4.2.1.1 in 37.213] | | | |
| 39 | Type1-ULChannelAccess defined in | 2 | 4 | 2 |
| | [clause 4.2.1.1 in 37.213] | | | |
| 40 | Type1-ULChannelAccess defined in | 3 | 1 | 1 |
| | [clause 4.2.1.1 in 37.213] | | | |
| 41 | Type1-ULChannelAccess defined in | 3 | 2 | 1 |
| | [clause 4.2.1.1 in 37.213] | | | |
| 42 | Type1-ULChannelAccess defined in | 3 | 3 | 1 |
| | [clause 4.2.1.1 in 37.213] | | | |
| 43 | Type1-ULChannelAccess defined in | 3 | 4 | 1 |
| | [clause 4.2.1.1 in 37.213] | | | |

In Table 5: “Entry index” refers to the index of the entry. “Channel Access Type” refers to the type of channel access. “Type1-ULChannelAccess defined in [clause 4.2.1.1 in 37.213]” refers to Type 1 UL channel access as defined in Clause 4.2.1.1 of 37.213. “Type2A-ULChannelAccess defined in [clause 4.2.1.2.1 in 37.213]” refers to Type 2A UL channel access as defined in Clause 4.2.1.2.1 of 37.213. “Type2B-ULChannelAccess defined in [clause 4.2.1.2.1 in 37.213]” refers to Type 2B UL channel access as defined in Clause 4.2.1.2.1 of 37.213. “Type2C-ULChannelAccess defined in [clause 4.2.1.2.1 in 37.213]” refers to Type 2C UL channel access as defined in Clause 4.2.1.2.1 of 37.213. These definitions specify different CAPCes (CAPC) applicable to various physical channels. “The CP extension T_‘ext’ index defined in Clause 5.3.1 of [4, 38.211]” refers to the extended index definition in Clause 5.3.1 of [4, 38.211]. “table” represents the CAPC table.

As described above, the processing method of the present application enables the channel to be accessed with the preset CAPC in response to satisfying a preset condition. The technical solution of the present application facilitates the determination of the CAPC based on downlink control information, thereby enabling different physical channels to use different CAPCes and ensuring that different physical channels access the unlicensed spectrum using different channel access parameters. This enhances the utilization of the unlicensed spectrum.

In an embodiment, the processing method of the present application may further include:
in response to satisfying a preset condition, determining a CAPC table based on downlink control information, determining the CAPC according to the CAPC table, and enabling the channel to be accessed with the preset CAPC.

That is, as shown in FIG. 4, step S11 further includes at least one of the following:

Step S114: in response to satisfying a preset condition, determining the CAPC table based on downlink control information, determining the CAPC according to the CAPC table, and enabling the channel to be accessed with the preset CAPC.

In an embodiment, when the terminal device executing the processing method according to the embodiment of the present application is preparing to transmit at least one of the PSCCH, the PSSCH, or the S-SS/PSBCH, the transmitter needs to perform Type 1 channel access. Before performing Type 1 channel access, a CAPC needs to be either preset or determined, which then determines parameters such as the defer duration, contention window size, and maximum COT, etc. These parameters are associated with the CAPC. Therefore, to determine parameters such as the defer duration, contention window size, and maximum COT, etc., the CAPC must first be determined.

In an embodiment, the transmitter dynamically indicates the CAPC table based on downlink control information, then determines the CAPC according to the CAPC table. The channel is subsequently accessed with the preset CAPC, and parameters such as the defer duration, contention window size, and maximum COT, etc., are determined.

In an embodiment, the transmitter dynamically indicates, based on downlink control information, the CAPC table corresponding to the currently transmitted PSCCH, PSSCH, and S-SS/PSBCH, as specified in Table 6.

In an embodiment, Table 6 includes eight priority classes, specifically used to indicate the priority classes for unicast and groupcast transmissions.

In an embodiment, different rows in Table 6 are used separately for unicast and/or groupcast transmissions.

TABLE 6

| CAPC | | | | | |
|---|---|---|---|---|---|
| (p) | mₚ | CW_{min, p} | CW_{max, p} | T_{m cot, p} | allowed CWₚsizes |
| 1 | 1 | 3 | 7 | 2 ms | {3, 7} |
| 2 | 1 | 7 | 15 | 3 ms | {7, 15} |
| 3 | 3 | 15 | 63 | 8 or 10 ms | {15, 31, 63} |
| 4 | 7 | 15 | 1023 | 8 or 10 ms | {15, 31, 63, 127, |
| | | | | | 255, 511, 1023} |
| 5 | 2 | 3 | 7 | 2 ms | {3, 7} |
| 6 | 2 | 7 | 15 | 4 ms | {7, 15} |
| 7 | 3 | 15 | 1023 | 6 ms or 10 ms | {15, 31, 63, 127, |
| | | | | | 255, 511, 1023} |
| 8 | 7 | 15 | 1023 | 6 ms or 10 ms | {15, 31, 63, 127, |
| | | | | | 255, 511, 1023} |

In Table 6: “CAPC (p)” represents the CAPC.

Represents the defer parameter corresponding to CAPC p.

Represents the minimum contention window size for CAPC p.

Represents the maximum contention window size for CAPC p.

Represents the maximum time that CAPC p can occupy the frequency band after an LBT succeeds.

“Allowed” represents the allowed contention window size for CAPC p.

In an embodiment, the transmitter dynamically indicates the CAPC table used for the currently transmitted PSCCH, PSSCH, and S-SS/PSBCH based on downlink control information, as shown in Table 7.

In Table 7:

“CAPC (p)” p represents the CAPC; mₚ represents the defer parameter for CAPC p; CW_{min, p} represents the minimum contention window size for CAPC p; CW_{max, p} represents the maximum contention window size for CAPC p; T_{m cot, p} represents the maximum duration that CAPC p can occupy the frequency band after an LBT succeeds; and allowed CWₚsizes represents the allowed contention window size for CAPC p.

In an embodiment, Table 7 contains seven priority classes, which can be specifically used to indicate the priority classes for unicast and groupcast transmissions.

In an embodiment, different rows in Table 7 are used separately for unicast and/or groupcast transmissions.

In an embodiment, if the transmitter's expected COT includes groupcast and/or broadcast services, the transmitter determines the specific CAPC p using the fourth decision rule. The channel is subsequently accessed with the preset CAPC, and parameters such as the defer duration, contention window size, and maximum COT, etc., are determined.

If the transmitter's expected COT does not include groupcast and/or broadcast services, the transmitter determines the specific CAPC p using the fifth decision rule. The channel is subsequently accessed with the preset CAPC, and parameters such as the defer duration, contention window size, and maximum COT, etc., are determined.

In an embodiment, the fourth and/or fifth decision rule also includes determining the CAPC p based on the logical channel corresponding to the PSSCH. For example, for voice services, the priority class is 1.

In an embodiment, the fourth and/or fifth decision rule also includes determining the CAPC p based on the receiver identifier of the PSSCH, such as the destination identifier.

In an embodiment, the fourth and/or fifth decision rule also includes determining the CAPC p based on the transmitter identifier of the PSSCH, such as the source identifier.

In an embodiment, the fourth and/or fifth decision rule also includes jointly determining the CAPC p based on the receiver and transmitter identifiers of the PSSCH. For example, selecting the lower priority class between the receiver and transmitter identifiers to determine CAPC p.

In an embodiment, the fourth and/or fifth decision rule also includes jointly determining the CAPC p based on the receiver and transmitter identifiers of the PSSCH. For example, selecting the higher priority class between the receiver and transmitter identifiers to determine CAPC p.

In an embodiment, if the number of receivers is greater than one, the lowest priority among the receivers is selected to determine the CAPC p.

In an embodiment, if the number of receivers is greater than one, the highest priority among the receivers is selected to determine the CAPC p.

In an embodiment, if the number of receivers is greater than one, a receiver is randomly selected, and its priority is used to determine the CAPC p.

In an embodiment, the priority is a PC5 5G QOS Identifier (PQI).

In an embodiment, the priority is the ProSe per-packet priority (PPPP), provided by the higher layer to the physical layer.

In an embodiment, there is a mapping relationship between the priority class p and the ProSe per-packet priority (PPPP).

As described above, the processing method of the present application enables the channel to be accessed with the preset CAPC in response to satisfying a preset condition. The present application explicitly defines the SL-U system's use of preset CAPCes for accessing the channel (determined from a CAPC table based on downlink control information). This facilitates the assignment of different CAPCes to different physical channels, ensuring that different physical channels use different channel access parameters when accessing the unlicensed spectrum, thereby improving spectrum utilization.

In an embodiment, the processing method of the present application further includes at least one of the following.

In response to satisfying a preset condition, determining the CAPC of the PSFCH based on the CAPC of the corresponding PSSCH, thereby enabling the channel to be accessed with the preset CAPC.

In response to satisfying a preset condition, setting a fixed predetermined value as the CAPC of the PSFCH, thereby enabling the channel to be accessed with the preset CAPC.

In response to satisfying a preset condition, determining the CAPC of the PSFCH based on the priority of the corresponding PSSCH, thereby enabling the channel to be accessed with the preset CAPC.

In response to satisfying a preset condition, when at least two PSFCHs are transmitted within the same PSFCH opportunity or within the same slot, the CAPC of the PSFCH with the highest priority determines the CAPC for the transmitting terminal in that PSFCH opportunity or time slot.

In response to satisfying a preset condition, when at least two PSFCHs start transmission at the same slot and/or symbol, the CAPC of the PSFCH with the highest priority determines the CAPC for the transmitting terminal at that same slot and/or symbol.

In an embodiment, when the terminal device executing the processing method of the present application is preparing to transmit a PSFCH, the transmitter needs to perform Type 1 channel access. Before performing Type 1 channel access, a CAPC needs to be either preset or determined, which then determines the defer duration, contention window size, and maximum COT. These parameters are associated with the CAPC. Therefore, to determine parameters such as the defer duration, contention window size, and maximum COT, etc., the CAPC must first be determined.

In an embodiment, the CAPC of the PSFCH is determined based on the CAPC of the corresponding PSSCH.

In an embodiment, the CAPC of the corresponding PSSCH is determined based on at least one of the following factors: the type of service contained in the transmission channel, downlink control information, the type of transmission channel, the logical channel corresponding to the PSSCH, the receiver identifier of the PSSCH, the transmitter identifier of the PSSCH, the combination of receiver and transmitter identifiers, the number of receivers, or the ProSe per-packet priority (PPPP). The determined PSSCH priority class is then used to determine the CAPC of the PSFCH.

In an embodiment, the CAPC of the corresponding PSSCH is determined based on multiple factors, including the type of service contained in the transmission channel, downlink control information, the type of the transmission channel, the logical channel corresponding to the PSSCH, the receiver identifier of the PSSCH, the transmitter identifier of the PSSCH, the combination of receiver and transmitter identifiers, the number of receivers, or the ProSe per-packet priority (PPPP). The determined PSSCH priority class is then used to determine the CAPC of the PSFCH.

In an embodiment, if the CAPC of the corresponding PSSCH is 1, the CAPC of the PSFCH is set to 1. If the PSSCH CAPC is 2, the corresponding PSFCH CAPC is set to 2. If the PSSCH CAPC is 3, the corresponding PSFCH CAPC is set to 3. If the PSSCH CAPC is 4, the corresponding PSFCH CAPC is set to 4.

In an embodiment, a fixed predetermined value is assigned as the CAPC of the PSFCH.

In an embodiment, the PSFCH CAPC is set to a constant value, such as 1.

In an embodiment, the PSFCH CAPC is determined based on the priority of the corresponding PSSCH, meaning the PSFCH CAPC is equivalent to the priority of the corresponding PSSCH.

In an embodiment, the priority is a PC5 5G QOS Identifier (PQI).

In an embodiment, there is a mapping relationship between the PSSCH CAPC and the ProSe per-packet priority (PPPP).

In an embodiment, the ProSe per-packet priority (PPPP) is provided by the higher layer to the physical layer.

In an embodiment, when at least two PSFCHs are transmitted in the same PSFCH opportunity or within the same slot, the PSFCH with the highest CAPC determines the CAPC for the transmitting terminal in that PSFCH opportunity or time slot.

In an embodiment, if at least two PSFCHs start transmission at the same slot and/or symbol, the PSFCH with the highest CAPC determines the CAPC for the transmitting terminal at that same slot and/or symbol.

As described above, the technical solution of the present application determines the CAPC of the PSFCH based on the CAPC of the corresponding PSSCH. This enables the channel to be accessed with the preset CAPC, thereby facilitating the allocation of different CAPCes to different physical channels and ensuring that different physical channels use different channel access parameters when accessing the unlicensed spectrum. As a result, high-priority services are prioritized for accessing the unlicensed spectrum, improving spectrum utilization.

The present application further provides a processing method, including:
step A10: transmitting downlink control information to enable the terminal device to determine the CAPC based on the downlink control information and subsequently access the channel with the preset CAPC.

In an embodiment, the processing method of the present application is applied to network device. The network device transmits downlink control information to enable the terminal device to determine the CAPC based on the downlink control information and subsequently access the channel with the preset CAPC.

And/or, the network device may transmit downlink control information to enable the terminal device to determine the CAPC table, then determine the CAPC based on the table, and subsequently access the channel with the preset CAPC.

In an embodiment, the terminal device directly indicates the CAPC by interpreting bit field in the downlink control information or newly added index information in the table indicated by the downlink control information. The channel is then accessed with the preset CAPC.

In an embodiment, the terminal device determines the CAPC by combining the downlink control information with other information and subsequently accesses the channel with the preset CAPC.

In an embodiment, the terminal device determines the corresponding CAPC based on a combination of downlink control information and the type of service contained in the transmission channel and subsequently accesses the channel with the preset CAPC.

In an embodiment, the terminal device determines the corresponding CAPC based on a combination of downlink control information and the receiver identifier of the PSSCH and subsequently accesses the channel with the preset CAPC.

In an embodiment, the method further includes at least one of the following:
determining the CAPC table based on bit field in the downlink control information and subsequently accessing the channel with the preset CAPC;
determining the CAPC table based on newly added column information in the table indicated by the downlink control information and subsequently accessing the channel with the preset CAPC;
determining the CAPC table based on newly added index information in the table indicated by the downlink control information and subsequently accessing the channel with the preset CAPC; and
the table indicated by the downlink control information being configured based on RRC signaling, and the channel being accessed with the preset CAPC.

In an embodiment, an additional 1-bit is added to the downlink control information to indicate the CAPC table, thereby enabling the channel to be accessed with the preset CAPC.

In an embodiment, an additional column is added to the table indicated by the downlink control information to specify the CAPC table, thereby enabling the channel to be accessed with the preset CAPC.

In an embodiment, the terminal device determines the CAPC table based on newly added index information in the table indicated by the downlink control information and subsequently accesses the channel with the preset CAPC.

In an embodiment, the number of rows in the table is increased to distinguish different CAPCes (CAPC). For example, if the first 43 rows indicate that the CAPC table is Table 1 and the last 43 rows indicate that the CAPC table is Table 2.

In an embodiment, the table indicated by the downlink control information is configured based on RRC signaling. In an embodiment, the RRC signaling configuration is determined based on higher-layer settings.

In an embodiment, after determining the CAPC table, the terminal device applies the sixth decision rule to determine the CAPC.

In an embodiment, the sixth decision rule includes determining the CAPC p based on the logical channel corresponding to the PSSCH. For example, for voice services, the CAPC p is 1. In an embodiment, the sixth decision rule further includes determining the CAPC p based on the receiver identifier of the PSSCH, such as the destination identifier. In an embodiment, the sixth decision rule further includes determining the CAPC p based on the transmitter identifier of the PSSCH, such as the source identifier. In an embodiment, the sixth decision rule further includes jointly determining the CAPC p based on the receiver and transmitter identifiers of the PSSCH. For example, selecting the lower priority class between the receiver and transmitter identifiers to determine CAPC p. In an embodiment, the sixth decision rule further includes selecting the higher priority class between the receiver and transmitter identifiers to determine CAPC p. In an embodiment, if the number of receivers is greater than one, the lowest priority among the receivers is selected to determine the CAPC p. In an embodiment, if the number of receivers is greater than one, the sixth decision rule selects the highest priority among the receivers to determine the CAPC p. In an embodiment, if the number of receivers is greater than one, the sixth decision rule randomly selects a receiver and determines the CAPC p based on its priority. In an embodiment, the priority is a PC5 5G QOS Identifier. In an embodiment, a mapping relationship exists between the priority class p and the ProSe per-packet priority (PPPP). In an embodiment, the priority is determined based on the ProSe per-packet priority (PPPP, ProSe per-packet priority), which is provided by the higher layer to the physical layer. After determining the CAPC p, the channel is accessed with the preset CAPC, and Table 1 is subsequently used to determine parameters such as the defer duration, contention window size, and maximum COT, etc.

In an embodiment, the sixth decision rule includes determining the CAPC p based on downlink control information. The channel is then accessed with the preset CAPC, and parameters such as the defer duration, contention window size, and maximum COT, etc., are determined according to Table 1.

In an embodiment, the terminal device determines the CAPC p based on bit field in the downlink control information, and subsequently determines parameters such as the defer duration, contention window size, and maximum COT, etc. In an embodiment, the terminal device determines the CAPC p based on newly added column information in the table indicated by the downlink control information, and subsequently determines parameters such as the defer duration, contention window size, and maximum COT, etc. In an embodiment, the terminal device determines the CAPC p based on newly added index information in the table indicated by the downlink control information, and subsequently determines parameters such as the defer duration, contention window size, and maximum COT, etc. In an embodiment, the CAPC p indicated by the downlink control information is configured based on RRC signaling.

As described above, the processing method of the present application involves the network device transmitting downlink control information to enable the terminal device to determine the CAPC and/or determine the CAPC table. The channel is then accessed with the preset CAPC. The technical solution of the present application enables the determination of the CAPC based on downlink control information, facilitating the assignment of different CAPCes to different physical channels. As a result, the channel is accessed with the preset CAPC, thereby improving the utilization of the unlicensed spectrum.

Please referring to FIG. 7, which is a schematic structural diagram of a communication device according to an embodiment of the present application. This device may be installed in the transmitter described in the method embodiments above, and the transmitter may specifically be a mobile terminal. The communication device shown in FIG. 7 may be used to execute part or all of the functions described in the method embodiments shown in FIG. 3, FIG. 4, and FIG. 6. The details of each unit are as follows.

Acquisition unit 1101: configured to determine preset conditions.

Processing unit 1102: configured to access the channel with a preset CAPC in response to satisfying the preset conditions.

In an embodiment, satisfying the preset conditions includes at least one of the following:
transmitted physical channels are different;
types of services contained in the transmitted channels are different;
there are different receivers;
there are different transmitters; and
channel priorities are different.

In an embodiment, the transmitted physical channel further includes at least one of the following:
transmitting a physical sidelink control channel;
transmitting a physical sidelink shared channel;
transmitting a physical sidelink feedback channel; and
transmitting a Sidelink-Synchronization Signal/Physical Sidelink Broadcast Channel block.

In an embodiment, the types of services contained in the transmitted channel further include at least one of the following:
the types of services contained in the transmitted channel include broadcast or groupcast;
the types of services contained in the transmitted channel include unicast; or
the types of services contained in the transmitted channel include unicast, broadcast and groupcast.

In an embodiment, processing unit 1102 is configured to:
determine the CAPC according to a type of service contained in a transmitting channel;
determine the CAPC according to downlink control information or a type of the transmitting channel;
determine the CAPC according to a logical channel corresponding to a physical sidelink shared channel;
determine the CAPC according to a receiver identifier of the physical sidelink shared channel;
determine the CAPC according to a transmitter identifier of the physical sidelink shared channel;
determine the CAPC based on the receiver identifier and the transmitter identifier of the physical sidelink shared channel;
determine the CAPC according to number of receivers;
determine the CAPC based on per-packet priority PPPP of proximity communication; and
determine the CAPC according to PC5 5G QOS identifier value.

The processing unit 1102 is further configured to:
in response to that the type of service contained in the transmitting channel includes broadcast and/or groupcast, use a first set CAPC to determine the CAPC; or
in response to that the type of service contained in the transmitting channel is unicast, use a second set CAPC to determine the CAPC.

In an embodiment, the processing unit 1102 is configured to:
ensure the first set CAPC and the second set CAPC belong to different CAPC tables respectively;
ensure that the first set CAPC and the second set CAPC belong to different elements in the same CAPC table.

In an embodiment, the processing unit 1102 is configured to:
determine a CAPC table according to the downlink control information, and determine the CAPC according to the CAPC table.

In an embodiment, the processing unit 1102 is configured to:
determine the CAPC table according to bit field in the downlink control information;
determine the CAPC table according to newly added column information in the table indicated by the downlink control information;
determine the CAPC table according to newly added index information in the table indicated by the downlink control information; and
configure a table indicated by the downlink control information based on RRC signaling.

In an embodiment, the processing unit 1102 is configured to:
in response to transmitting the physical sidelink shared channel, determine the CAPC;
in response to transmitting a physical sidelink control channel, determine the CAPC;
in response to transmitting a physical sidelink feedback channel, determine the CAPC; and
in response to transmitting a Sidelink-Synchronization Signal/Physical Sidelink Broadcast Channel block, determine the CAPC.

In an embodiment, the processing unit 1102 is configured to:
determine the CAPC of the physical sidelink feedback channel according to the CAPC to which the corresponding physical sidelink shared channel belongs;
determine a fixed preset value as the CAPC of the physical sidelink feedback channel;
determine the CAPC of the physical sidelink feedback channel according to a priority of the corresponding physical sidelink shared channel;
in response to that at least two physical sidelink feedback channels are transmitted at the same physical sidelink feedback channel occasion or in the same slot, determine the CAPC of the transmitting terminal at the physical sidelink feedback channel occasion or in the time slot according to the physical sidelink feedback channel with a higher CAPC; and
in response to that at least two physical sidelink feedback channels start to be sent at the same slot and/or symbol, determine the CAPC of the transmitting terminal at the same slot and/or symbol of the physical sidelink feedback channel according to the physical sidelink feedback channel with a higher CAPC.

In an embodiment, the processing unit 1102 is configured to:
in response to that the number of receivers is greater than 1, determine the CAPC according to a priority of the receiver with lowest priority;
in response to that the number of receivers is greater than 1, determine the CAPC according to a priority of the receiver with highest priority; and
in response to that the number of receivers is greater than 1, determine the CAPC according to a priority of a randomly selected receiver.

In an embodiment, the processing unit 1102 is configured to:
determine a minimum CAPC based on the receiver identifier and the transmitter identifier as the CAPC; or
determine a maximum CAPC based on the receiver identifier and the transmitter identifier as the CAPC.

In an embodiment, the processing unit 1102 is configured to:
determine at least one parameter of a defer duration, an allowed contention window size, and a maximum COT.

According to an embodiment of the present application, some steps involved in the image processing method shown in FIG. 3, FIG. 4 and FIG. 6 can be performed by various modules in the image communication apparatus shown in FIG. 7. The various units in the image communication apparatus shown in FIG. 7 can be respectively or completely combined into one or several other modules to form, or one (some) of the modules can be further divided into multiple functionally smaller units to form, which can achieve the same operation without affecting the realization of the technical effect of the embodiment of the present application. The above units are divided based on logical functions. In practical applications, the function of one module can also be realized by multiple modules, or the functions of multiple modules can be realized by one module. In other embodiments of the present application, the image communication apparatus can also include other modules. In practical applications, these functions can also be implemented with the assistance of other modules, and can be implemented by multiple modules in collaboration.

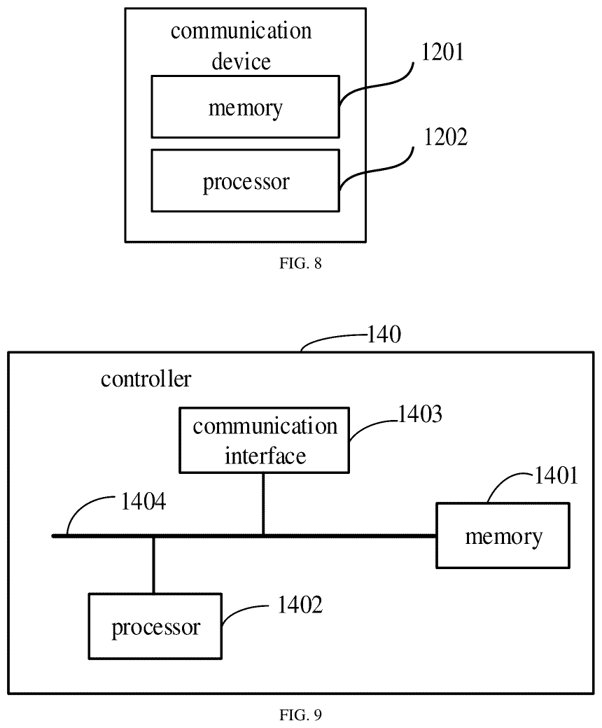

Please referring to FIG. 8, which is a structural diagram of another communication device according to an embodiment of the present application. The present application further provides a communication terminal, the mobile terminal includes a memory 1201, a processor 1202, and a processing program stored in the memory 1201 and executable on the processor 1202, and the processing program is executed by the processor to implement the steps of the processing method in any of the above embodiments.

The present application further provides a communication device, including: memory, processor, and processing program stored on memory and executable on the processor, when the processing program is executed by the processor, the steps of the processing method in any of the above embodiments are implemented.

The present application further provides a computer-readable storage medium, on which a computer program is stored, and the computer program is executed by the processor to implement the steps of the processing method in any of the above embodiments.

In the embodiments of the mobile terminal and computer-readable storage medium provided by the present application, all technical features of the embodiments of the above processing methods are included, and the expansion and explanation of the specification are basically the same as the embodiments of the above call note method, which will not be repeated here.

The present application further provides a computer program product, which includes a computer program code, and when the computer program code is executed on a computer, the computer executes the methods in the above various possible implementations.

The present application further provides a chip, including a memory and a processor, the memory is used to store a computer program, and the processor is used to call and run the computer program from the memory, so that the device equipped with the chip executes the methods in the above various possible implementations.

The present application further provides a computer device for executing the methods in the above various possible implementations.

The computing device generally includes a processor and a memory, and the memory is used to store instructions. When the instructions are executed by the processor, the computing device executes the steps or program modules of the present application.

FIG. 9 is a schematic diagram of a hardware structure of a controller 140 according to the present application. The controller 140 includes a memory 1401 and a processor 1402, and the memory 1401 stores program instructions, and the processor 1402 calls the program instructions in the memory 1401 to execute the steps performed by the controller in the above method embodiment, and its implementation principle and beneficial effects are similar, which will not be repeated herein.

In an embodiment, the above controller further includes a communication interface 1403, which can be connected to the processor 1402 through a bus 1404. The processor 1402 can control the communication interface 1403 to realize the receiving and transmitting functions of the controller 140.

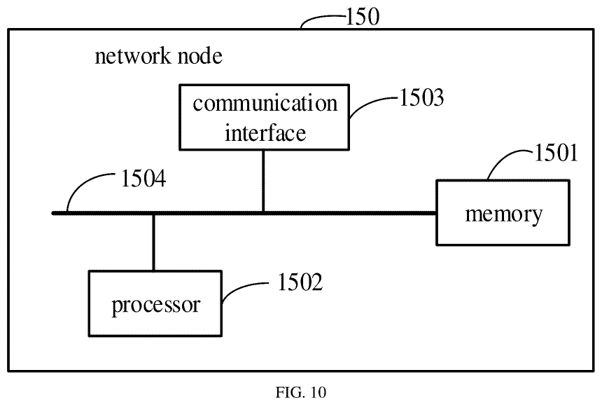

FIG. 10 is a schematic diagram of a hardware structure of a network node 150 according to the present application. The network node 150 includes a memory 1501 and a processor 1502, the memory 1501 stores program instructions, and the processor 1502 calls the program instructions in the memory 1501 to execute the steps performed by the network device in the above-mentioned method embodiment, and its implementation principle and beneficial effects are similar, which will not be repeated herein.

In an embodiment, the above-mentioned network node further includes a communication interface 1503, and the communication interface 1503 can be connected to the processor 1502 through a bus 1504. The processor 1502 can control the communication interface 1503 to realize the receiving and transmitting functions of the network node 150.

The above-mentioned integrated module implemented in the form of a software function module can be stored in a computer-readable storage medium. The above-mentioned software function module is stored in a storage medium, including several instructions for enabling a computer device (which can be a personal computer, a server, or a network device, etc.) or a processor to perform some steps of the methods of various embodiments of the present application.

In the above embodiments, it can be implemented in whole or in part by software, hardware, firmware, or any combination thereof. When implemented using software, it may be implemented in whole or in part in the form of a computer program product. The computer program product includes one or more computer instructions. When computer program instructions are loaded and executed on a computer, processes or functions according to embodiments of the present application are generated in whole or in part. The computer may be a general purpose computer, a special purpose computer, a computer network, or other programmable device. The computer instruction may be stored in or transmitted from one computer-readable storage medium to another computer-readable storage medium. For example, the computer instruction may be transmitted by wired (e.g., coaxial cable, optical fiber, digital subscriber line) or wireless (e.g., infrared, wireless, microwave, etc.) means from one website, computer, server, or data center to another website, computer, server, or data center. Computer-readable storage media can be any available media that can be accessed by a computer or a data storage device such as a server, data center, or other integrated media that contains one or more available media. Available media may be magnetic media (e.g., floppy disk, storage disk, tape), optical media (e.g., DVD), or semiconductor media (e.g., Solid State Disk (SSD)), etc.

The serial numbers of the embodiments of the present application are only for description and do not represent the advantages and disadvantages of the embodiments.

In the present application, the same or similar terms, concepts, technical solutions and/or application scenario descriptions are generally described in detail only the first time they appear. When it appears again later, for the sake of brevity, it is generally not repeated. When understanding the technical solutions and other content of the present application, the same or similar term concepts, technical solutions and/or application scenario descriptions that are not described in detail later can refer to the relevant previous detailed descriptions.

In the present application, each embodiment is described with its own emphasis. For parts that are not detailed or recorded in a certain embodiment, please refer to the relevant descriptions of other embodiments.

The technical features of the technical solution of the present application can be combined in any way. To simplify the description, all possible combinations of the technical features in the above embodiments are not described. However, as long as there is no contradiction in the combination of these technical features, it should be considered to be within the scope of the present application.

Through the above description of the implementation, those skilled in the art can clearly understand that the above embodiment methods can be implemented by software plus the necessary general hardware platform, or by hardware, but in many cases the former is a better implementation. Based on this understanding, the technical solution of the present application essentially or the part that contributes to the existing technology can be embodied in the form of a software product, and the computer software product is stored in one of the above storage media (such as ROM/RAM, disk, optical disk), including several instructions to cause a terminal device (which can be a mobile phone, a computer, a server, a controlled terminal, or a network device, etc.) to execute the method of each embodiment of the present application.

The above are only some embodiments of the present application, and are not intended to limit the scope of the present application. Any equivalent structure or equivalent process transformation made using the contents of the specification and drawings of the present application, or directly or indirectly applied in other related technical fields, shall be similarly included in the scope of the present application.

What is claimed is:

1. A processing method, comprising:
in response to satisfying a preset condition, accessing a channel with a preset channel access priority class; and
determining the channel access priority class according to a type of a transmitted channel.

2. The method according to claim 1, wherein the satisfying the preset condition comprises at least one of the following:
transmitted physical channels being different;
types of services contained in the transmitted channels being different;
there being different receivers;
there being different transmitters; and
channel priorities being different.

3. The method according to claim 2, wherein the transmitted physical channel further comprises at least one of the following:
transmitting a physical sidelink control channel;
transmitting a physical sidelink shared channel;
transmitting a physical sidelink feedback channel; and
transmitting a sidelink-synchronization signal and physical sidelink broadcast channel block.

4. The method according to claim 2, wherein the types of services contained in the transmitted channel further comprise at least one of the following:
the types of services contained in the transmitted channel comprising broadcast or groupcast;
the types of services contained in the transmitted channel comprising unicast; and
the types of services contained in the transmitted channel comprising unicast, broadcast and groupcast.

5. The method according to claim 1, wherein a way for determining the preset channel access priority class comprises at least one of the following:
determining the channel access priority class according to a type of service contained in a transmitted channel;
determining the channel access priority class according to downlink control information;
determining the channel access priority class according to a logical channel corresponding to a physical sidelink shared channel;
determining the channel access priority class according to a receiver identifier of the physical sidelink shared channel;
determining the channel access priority class according to a transmitter identifier of the physical sidelink shared channel;
determining the channel access priority class based on the receiver identifier and the transmitter identifier of the physical sidelink shared channel;
determining the channel access priority class according to number of receivers;
determining the channel access priority class based on per-packet priority PPPP of proximity communication; and
determining the channel access priority class according to PC5 5G QOS identifier value.

6. The method according to claim 5, further comprising at least one of the following:
in response to that the type of service contained in the transmitting channel comprises broadcast and/or groupcast, using a first set channel access priority class to determine the channel access priority class; and
in response to that the type of service contained in the transmitting channel is unicast, using a second set channel access priority class to determine the channel access priority class.

7. The method according to claim 6, further comprising at least one of the following:
the first set channel access priority class and the second set channel access priority class belonging to different channel access priority class tables respectively; and
the first set channel access priority class and the second set channel access priority class belonging to different elements in the same channel access priority class table.

8. The method according to claim 5, further comprising at least one of the following:
determining a channel access priority class table according to the downlink control information; and
determining the channel access priority class according to the channel access priority class table.

9. The method according to claim 8, wherein a table indicated by the downlink control information is configured according to radio resource control (RRC) signaling; and/or, the determining the channel access priority class table according to the downlink control information further comprises at least one of the following:
determining the channel access priority class table according to bit field in the downlink control information;
determining the channel access priority class table according to newly added column information in the table indicated by the downlink control information; and
determining the channel access priority class table according to newly added index information in the table indicated by the downlink control information.

10. The method according to claim 5, further comprising at least one of the following:
in response to transmitting the physical sidelink shared channel, determining the channel access priority class;
in response to transmitting a physical sidelink control channel, determining the channel access priority class;
in response to transmitting a physical sidelink feedback channel, determining the channel access priority class; and
in response to transmitting a sidelink-synchronization signal/physical sidelink broadcast channel block, determining the channel access priority class.

11. The method according to claim 10, further comprising at least one of the following:
determining the channel access priority class of the physical sidelink feedback channel according to the channel access priority class to which the corresponding physical sidelink shared channel belongs;
determining a fixed preset value as the channel access priority class of the physical sidelink feedback channel;
determining the channel access priority class of the physical sidelink feedback channel according to a priority of the corresponding physical sidelink shared channel;
in response to that at least two physical sidelink feedback channels are transmitted at the same physical sidelink feedback channel occasion or in the same slot, determining the channel access priority class of the transmitting terminal at the physical sidelink feedback channel occasion or in the slot according to the physical sidelink feedback channel with a higher channel access priority class; and
in response to that at least two physical sidelink feedback channels start to be transmitted at the same slot and/or symbol, determining the channel access priority class of the transmitting terminal at the same slot and/or symbol of the physical sidelink feedback channel according to the physical sidelink feedback channel with a higher channel access priority class.

12. The method according to claim 5, further comprising at least one of the following:
in response to that the number of receivers is greater than 1, determining the channel access priority class according to a priority of the receiver with lowest priority;
in response to that the number of receivers is greater than 1, determining the channel access priority class according to a priority of the receiver with highest priority; and
in response to that the number of receivers is greater than 1, determining the channel access priority class according to a priority of a randomly selected receiver.

13. The method according to claim 5, wherein a way for determining the channel access priority class based on the receiver identifier and the transmitter identifier of the physical sidelink shared channel further comprises at least one of the following:
determining a minimum channel access priority class based on the receiver identifier and the transmitter identifier as the channel access priority class; and
determining a maximum channel access priority class based on the receiver identifier and the transmitter identifier as the channel access priority class.

14. The method according to claim 5, further comprising at least one of the following:
determining the channel access priority class based on a resource type corresponding to the PC5 5G QoS identifier value;
determining the channel access priority class based on a default priority corresponding to the PC5 5G QoS identifier value;
determining the channel access priority class based on a packet error rate corresponding to the PC5 5G QoS identifier value; and
determining the channel access priority class based on a packet delay budget corresponding to the PC5 5G QoS identifier value.

15. The method according to claim 1, further comprising:
determining at least one parameter of a defer duration, an allowed contention window size, and a maximum channel occupancy time.

16. A processing method, comprising:
transmitting downlink control information so that a terminal device uses the downlink control information to determine a channel access priority class and access a channel with a preset channel access priority class.

17. The method according to claim 16, wherein a table indicated by the downlink control information is configured according to RRC signaling; and/or the transmitting the downlink control information so that the terminal device uses the downlink control information to determine the channel access priority class comprises at least one of the following:
indicating, by the terminal device, the channel access priority class according to bit field in the downlink control information or newly added index information in the table indicated by the downlink control information;
indicating, by the terminal device, the channel access priority class according to the downlink control information and other information;
indicating, by the terminal device, the corresponding channel access priority class according to the downlink control information and the service type contained in the transmission channel;
indicating, by the terminal device, the channel access priority class according to the downlink control information and the receiver identifier of the physical sidelink shared channel;
determining, by the terminal device, the channel access priority class table according to the bit field in the downlink control information, and determines the channel access priority class according to the sixth decision rule;
determining, by the terminal device, the channel access priority class table according to the newly added column information in the table indicated by the downlink control information, and determining the channel access priority class according to a sixth decision rule; and
determining, by the terminal device, the channel access priority class table according to the newly added index information in the table indicated by the downlink control information, and determining the channel access priority class according to a sixth decision rule.

18. A communication device, comprising: a memory, a processor, and a processing program stored in the memory and executable on the processor, wherein the processing program implements the processing method according to claim 1 when executed by the processor.

19. A communication device, comprising: a memory, a processor, and a processing program stored in the memory and executable on the processor, wherein the processing program implements the processing method according to claim 16 when executed by the processor.

20. A non-transitory computer-readable storage medium, wherein a computer program is stored in the non-transitory computer-readable storage medium, and when the computer program is executed by a processor, the processing method according to claim 1 is implemented.
